(19) United States
(12) Patent Application Publication
(10) Pub. No.: US 2009/0153757 A1
(43) Pub. Date: Jun. 18, 2009

(54) LIQUID CRYSTAL DISPLAY ELEMENT, METHOD OF DRIVING THE ELEMENT, AND ELECTRONIC PAPER HAVING THE ELEMENT

(75) Inventor: Masaki NOSE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/389,814

(22) Filed: Feb. 20, 2009

Related U.S. Application Data
(63) Continuation of application No. PCT/JP2006/316528, filed on Aug. 23, 2006.

(51) Int. Cl. G09G 3/36; G02F 1/137

(52) U.S. Cl. 349/35; 345/89

(57) ABSTRACT

The invention relates to a liquid crystal display element for displaying an image by driving a liquid crystal and provides a liquid crystal display element capable of multi-level display of high display quality using general-purpose drivers, a method of driving the element, and electronic paper having the element. To display gray level “4”, a pulse voltage of ±32 V is applied at a first step to put a cholesteric liquid crystal in a planar state (level “7”)). Then, a pulse voltage of ±24 V is applied for 2.0 ms at a sub-step to the cholesteric liquid crystal to change the gray level to level “5” that is two steps lower. A pulse voltage of ±24 V is applied for 1.0 ms at another sub-step to cause a further transition of the cholesteric liquid crystal toward a focal conic state, thereby obtaining gray level “4” that is one step lower than level “5”.

This application is a continuation of International Application No. PCT/JP2006/316528, filed Aug. 23, 2006.

### BACKGROUND

1. Field

The present invention relates to a liquid crystal display element which displays an image by driving a liquid crystal, a method of driving the element, and electronic paper having the element.

2. Description of the Related Art

Recently, various enterprises and universities are actively engaged in the development of electronic paper. The most promising application of electronic paper is electronic books, and other promising applications include portable apparatus such as mobile terminal sub-displays and display portions of IC cards. One type of display elements used in electronic paper is liquid crystal display elements utilizing a liquid crystal composition which forms a cholesteric phase (such a composition is referred to as “cholesteric liquid crystal” or “chiral nematic liquid crystal” and the term “cholesteric liquid crystal” will be used hereinafter). A cholesteric liquid crystal has excellent characteristics such as semi-permanent display retention characteristics (memory characteristics), vivid color display characteristics, high contrast characteristics, and high resolution characteristics.

FIG. 25 schematically shows a sectional configuration of a liquid crystal display element 51 capable of full-color display utilizing a cholesteric liquid crystal. The liquid crystal display element 51 has a structure in which a blue (B) display portion 46b, a green (G) display portion 46g, and a red (R) display portion 46r are formed one over another in the order listed from a side of the element where a display surface is provided. In the illustration, the display surface is on the side where a top substrate 47b is provided, and light from outside the element (the arrow in a solid line) impinges on the display surface from above the substrate 47b. An eye of a viewing person and the viewing direction of the viewer (the arrow in a broken line) are schematically illustrated above the substrate 47b.

The B display portion 46b includes a blue (B) liquid crystal layer 43b enclosed between a pair of substrates, i.e., a top substrate 47b and a bottom substrate 49b and a pulse voltage source 41b for applying a predetermined pulse voltage to the B liquid crystal layer 43b. The G display portion 46g includes a green (G) liquid crystal layer 43g enclosed between a pair of substrates, i.e., a top substrate 47g and a bottom substrate 49g and a pulse voltage source 41g for applying a predetermined pulse voltage to the G liquid crystal layer 43g. The R display portion 46r includes a red (R) liquid crystal layer 43r enclosed between a pair of substrates, i.e., a top substrate 47r and a bottom substrate 49r and a pulse voltage source 41r for applying a predetermined pulse voltage to the R liquid crystal layer 43r. A light absorbing layer 45 is disposed on a bottom surface of the bottom substrate 49r of the R display portion 46r.

The cholesteric liquid crystal used in each of the B, G, and R liquid crystal layers 43b, 43g, and 43r is a liquid crystal mixture obtained by adding a relatively great amount of a chiral additive (also referred to as “chiral material”) to a nematic liquid crystal to a chiral content of several tens percent by weight. When a nematic liquid crystal includes a relatively great amount of chiral material, a cholesteric phase that is a strong helical twist of nematic liquid crystal molecules can be formed.

A cholesteric liquid crystal has bistability (memory characteristics), and the liquid crystal can be put in any of a planar state, a focal conic state, or an intermediate state which is a mixture of the planar state and the focal conic state by adjusting the intensity of an electric field applied to the same. Once the liquid crystal enters the planar state, the focal conic state, or the intermediate state, i.e., the mixed state, the liquid crystal thereafter stays in the state with stability even if the electric field is removed.

The planar state can be obtained by applying a predetermined high voltage between a top substrate 47 and a bottom substrate 49 to put a liquid crystal layer 43 in an intense electric field and by abruptly nullifying the electric field thereafter. The focal conic state can be obtained by applying a predetermined voltage lower than, for example, the above-described high voltage between the top substrate 47 and the bottom substrate 49 to put the liquid crystal layer 43 under an electric field and by abruptly nullifying the electric field thereafter.

The intermediate state or a mixture of the planar state and the focal conic state can be obtained by applying a voltage lower than, for example, the voltage providing the focal conic state between the top substrate 47 and the bottom substrate 49 to put the liquid crystal layer 43 under an electric field and by abruptly nullifying the electric field thereafter.

The B display portion 46b will now be described as an example to explain a principle of display operation of the liquid crystal display element 51 utilizing a cholesteric liquid crystal. FIG. 26A shows alignment of cholesteric liquid crystal molecules 33 in the B liquid crystal layer 43b of the B display portion 46b in The planar state. As shown in FIG. 26A, in the planar state, the liquid crystal molecules 33 are sequentially rotated from one another in the direction of the thickness of the substrates to form a helical structure, and helical axes of the helical structure are substantially perpendicular to substrate surfaces.

In the planar state, light rays in a predetermined wave band in accordance with the helical pitch of the liquid crystal molecules 33 are selectively reflected by the liquid crystal layer. The reflected light rays are circularly polarized light rays which are either left-handed or right-handed depending on the chirality of the helical pitch. Other types of light rays are transmitted through the liquid crystal layer. Natural light is a mixture of left- and right-handed circularly polarized light rays. Therefore, when natural light in the predetermined wave band enters the liquid crystal layer in the planar state, it is assumed that 50% of the incident light is reflected and the other 50% of the incident light is transmitted by the layer.

A wavelength λ which results in the maximum reflection is given by an equation λ=n·p where n and p represent the average refractive index and the helical pitch of the liquid crystal layer, respectively.

Therefore, the average refractive index n and the helical pitch p of the B liquid crystal layer 43b of the B display portion 46b are determined, for example, such that an equation λ=480 nm becomes true in order to allow blue light to be selectively reflected by the layer in the planar state. The average refractive index n can be adjusted by selecting the liquid crystal material and the chiral material appropriately, and the helical pitch p can be adjusted by adjusting the chiral material content.

FIG. 26B shows alignment of the cholesteric liquid crystal molecules 33 observed when the B liquid crystal layer 43b of the B display portion 46b is in the focal conic state. As show in FIG. 26B, in the focal conic state, the liquid crystal molecules 33 are sequentially rotated from one another in an in-plane direction of the substrates to form a helical structure, and helical axes of the helical structure are substantially parallel to the substrate surfaces. In the focal conic state, the B liquid crystal layer 43b loses the property of selectively reflecting certain wavelengths, and most of light incident on the layer is transmitted. Since the transmitted light is absorbed by the light absorbing layer 45 provided on the bottom surface of the bottom substrate 49r of the R display portion 46r, a dark state (black) can be displayed.

In the intermediate state that is a mixture of the planar state and the focal conic state, the ratio between reflected light and transmitted light is adjusted according to the ratio between the planar state and the focal conic state, and the intensity of reflected light changes accordingly. Thus, multi-level display can be achieved according to intensities of reflected light.

As thus described, the amount of light reflected by the cholesteric liquid crystal can be controlled by the spirally twisted alignment of the liquid crystal molecules 33. Cholesteric liquid crystals which selectively reflect green and red light rays, respectively, in the planar state are enclosed on the G liquid crystal layer 43g and the R liquid crystal layer 43r, respectively, in the same way as done for the B liquid crystal layer 43b to fabricate a liquid crystal display element 51 capable of full-color display. The liquid crystal display element 51 has memory characteristics, and the element can therefore perform full-color display without consuming electric power except when rewriting the screen.

Patent Document 1: JP-A-2001-228459

Patent Document 2: JP-A-2003-228045

Patent Document 3: JP-A-2000-2869

Patent Document 4: JP-A-11-326871

Patent Document 5: JP-A-2005-345661

Non-Patent Document 1: Nam-Seok Lee, Hyun-Soo Shin, etc., A Novel Dynamic Drive Scheme for Reflective Cholesteric Displays, SID 02 DIGEST, pp. 546-549, 2002

Non-Patent Document 2: Y.-M. Zhu, D.-K Yang, Cumulative Drive Schemes for Bistable Reflective Cholesteric LCDs, SID 98 DIGEST, pp. 798-801, 1998

Methods of multi-level display utilizing a cholesteric liquid crystal disclosed in the related art will now be described along with their problems.

For example, JP-A-2001-228459 and JP-A-2003-228045 disclose methods called dynamic driving in which halftones are displayed using different amplitudes, pulse widths or phases in “a selection section” of a driving waveform having three stages, i.e., “a preparation section”, “a selection section”, and “an Evolution section”. However, those schemes for dynamic driving have the problem of high granularity in halftones, although they allow high speed driving.

In general, dynamic driving necessitates a dedicated driver capable of providing a multiplicity of voltage outputs, and the manufacture of such a driver and the complicatedness of a control circuit for the driver can be significant sources of a cost increase.

Non-Patent Document (Nam-Seok Lee, Hyun-Soo Shin, etc., A Novel Dynamic Drive Scheme for Reflective Cholesteric Displays, SID 02 DIGEST, pp. 546-549, 2002) discloses a method of dynamic driving which can be implemented using an inexpensive general-purpose STN driver. However, the method is not expected to eliminate high granularity that is a problem with dynamic driving.

JP-A-2000-2869 discloses a method in which second and third pulses are applied to a liquid crystal immediately after applying a first pulse to make the liquid crystal homeotropic. Thus, a desired tone can be displayed using a potential difference between the second and third pulses. The driving method still leaves the concern about granularity of intermediate tones unsolved, and the method has another problem in that a product cannot be manufactured in an inexpensive configuration because a high driving voltage is required.

All of the above-described driving methods according to the related art utilize a halftone region B as shown in FIG. 4 which will be described later. Therefore, the driving methods result in images having high granularity although they allow high speed driving, and a problem still therefore remains in display quality.

A driving method utilizing a halftone region A as shown in FIG. 4 is disclosed in Non-Patent Document (Y.-M. Zhu, D.-K Yang, Cumulative Drive Schemes for Bistable Reflective Cholesteric LCDs, SID 98 DIGEST, pp. 798-801, 1998), and the method also has a problem.

Non-Patent Document (Y.-M. Zhu, D.-K Yang, Cumulative Drive Schemes for Bistable Reflective Cholesteric LCDs, SID 98 DIGEST, pp. 798-801, 1998) discloses a method which takes advantage of cumulative response (overwritable) properties unique to liquid crystals. Specifically, relatively short pulses are applied to a liquid crystal to drive it gradually from the planar state to the focal conic state or from the focal conic state to the planar state at a rate as high as the rate of quasi-motion pictures.

However, since the method allows driving a relatively high rate, a drive voltage as high as 50 to 70 V is required, which can result in a cost increase. This method or “two phase cumulative drive scheme” has two stages, i.e., “a preparation phase” and “a selection phase” for performing display utilizing cumulative responses in two directions, i.e., cumulative responses toward the planar state and cumulative responses toward the focal conic state (or an intermediate gray level region A and an intermediate gray level region B). Such an approach results in a problem in display quality.

JP-A-11-326871 discloses a method in which a screen is entirely turned off or reset to the focal conic state and a selection pulse for determining gray levels and a hold pulse for stabilizing the display state are thereafter applied to perform multi-level display at a maximum of 256 gray levels. The gray levels are obtained using a PWM (pulse width modulation) process for switching the pulse width of the selection pulse at 256 steps, and there is no need for any special process for converting image data.

According to JP-A-11-326871, an IC having a special configuration must be used as a data driver for allowing pulse widths as many as 256 at maximum to be output from each electrode. Further, a data output clock having 256 periods is required. The use of a PWM process necessitates a great amount of image data in proportion to the number of gray levels to be provided, although such a problem is not peculiar to the PWM process described in JP-A-11-326871.

FIGS. 27A to 27C illustrate the problem with PWM type driving. When eight gray levels, e.g., gray levels 0 (black) to 7 (white) are displayed as shown in FIG. 27A, one piece of gray level data is represented by a string of eight bits in total, in which the most significant bit is a reset bit and the lower seven bits are gray level bits as shown in FIG. 27B. A voltage applied to a pixel is controlled to obtain eight pulse widths based on such gray level data, as shown in FIG. 27C. That is, a great amount of image data in proportion to the number of gray levels is required.

JP-A-2005-345661 discloses a scheme for a wide-screen display apparatus utilizing a cholesteric liquid crystal. According to the disclosure, determination is made on whether an image to be displayed is binary or it is multi-valued, and different characteristic regions are used for binary display and multi-valued display. Specifically, an intermediate gray level region B and an intermediate gray level region A as shown in FIG. 4 are used for binary display and multi-valued display, respectively. A gray level is determined by a voltage value. Although not disclosed in JP-A-2005-345661, a reset process must be always performed when the intermediate gray level region B is used.

### SUMMARY

It is an object of the invention to provide a liquid crystal display element capable of multi-level display of high display quality using a general-purpose driver, a method of driving the element, and electronic paper having the element.

The above-described object is achieved by a method of driving a liquid crystal display element for displaying gray levels by changing a reflectance of a liquid crystal layer, the method comprising, a first step of changing the reflectance of the liquid crystal layer to a first reflectance value to obtain a first gray level, and a second step of changing the reflectance of the liquid crystal layer to a second reflectance value lower than the first reflectance value to obtain a second gray level lower than the first gray level.

The above invention is characterized in that the second step includes n sub-steps to gradually decrease the first reflectance value to the second reflectance value. The above invention is characterized in that N gray levels (N is a power of 2) are displayed by the first step and the sub-steps totaling at a number of steps log₂N. The above invention is characterized in that the first reflectance value is either of two reflectance values one of which is substantially one half of the other.

The above invention is characterized in that the first step includes applying a first voltage having a first pulse width between a pair of electrodes sandwiching the liquid crystal layer to generate the first reflectance value. The above invention is characterized in that the second step includes n sub-steps applying a voltage lower than the first voltage having a pulse width smaller than the first pulse width between the electrodes to generate the second reflectance value. The above invention is characterized in that the liquid crystal layer has a first intermediate gray level region in which an increase in an applied voltage results in a decrease in reflectance and a second intermediate gray level region which is a voltage range higher than a voltage range associated with the first intermediate gray level region and in which an increase in an applied voltage results in an increase in reflectance, the first voltage at the first step is in the second intermediate gray level region, and the low voltage at the second step is in the first intermediate gray level region.

The above invention is characterized in that the liquid crystal layer includes a liquid crystal which forms a cholesteric phase. The above invention is characterized in that the first reflectance value is generated when the liquid crystal is in a planar state or a state that is a mixture of the planar state and a focal conic state. The above invention is characterized in that the first step includes the step of resetting the liquid crystal to a homeotropic state or the focal conic state before changing the reflectance of the liquid crystal layer to the first reflectance value.

The above invention is characterized in that one of the pair of electrodes is one of scan electrodes sequentially scanned in one frame to select a plurality of pixels on one line and the other electrode is one of data electrodes for applying a data voltage to each of the pixels, and the first step and the second step are performed in different frames. The above invention is characterized in that a selection period for the scan electrode is varied to control each pulse width used at the sub-steps. The above invention is characterized in that a bit array for controlling the selection period is provided to modulate a frequency division ratio of a counter for controlling the selection period according to the value of the bit array.

The above-described object is achieved by a liquid crystal display element comprising; a liquid crystal layer enclosed between a pair of substrates, a pair of electrodes sandwiching the liquid crystal layer, and a driving device for displaying gray levels by performing a first step of changing a reflectance of the liquid crystal layer to a first reflectance value to obtain a first gray level and a second step of changing the reflectance of the liquid crystal layer to a second reflectance value lower than the first reflectance value to obtain a second gray level lower than the first gray level.

The above invention is characterized in that the driving device performs n sub-steps at the second step to gradually decrease the first reflectance value to the second reflectance value for displaying gray levels. The above invention is characterized in that N gray levels (N is a power of 2) are displayed by the first step and the sub-steps totaling at a number of steps log₂N by the driving device. The above invention is characterized in that the first reflectance value is either of two reflectance values one of which is substantially one half of the other. The above invention is characterized in that the driving device applies a first voltage having a first pulse width between a pair of electrodes to generate the first reflectance value at the first step. The above invention is characterized in that the driving device performs n sub-steps in the second step to apply a voltage lower than the first voltage having a pulse width smaller than the first pulse width between the electrodes to generate the second reflectance value. The above invention is characterized in that the liquid crystal layer has a first intermediate gray level region in which an increase in an applied voltage results in a decrease in reflectance and a second intermediate gray level region which is a voltage range higher than a voltage range associated with the first intermediate gray level region and in which an increase in an applied voltage results in an increase in reflectance, and the driving device uses a voltage in the second intermediate gray level region as the first voltage of the first step and a voltage in the first intermediate gray level region as the lower voltage of the second step. The above invention is characterized in that the liquid crystal layer includes a liquid crystal which forms a cholesteric phase.

The above invention is characterized in that the first reflectance value is generated when the liquid crystal is in a planar state or a state that is a mixture of the planar state and a focal conic state. The above invention is characterized in that the driving device performs a step included in the first step to reset the liquid crystal to a homeotropic state or the focal conic state before changing the reflectance of the liquid crystal layer to the first reflectance value.

The above invention is characterized in that one of the pair of electrodes is one of scan electrodes sequentially scanned in one frame to select a plurality of pixels on one line and the other electrode is one of data electrodes for applying a data voltage to each of the pixels, and the first step and the second step are performed in different frames.

The above invention is characterized in that the driving device varies a selection period for the scan electrode to control each pulse width used at the sub-steps. The above invention is characterized in that the driving device has a bit array for controlling the selection period to modulate a frequency division ratio of a counter for controlling the selection period according to the value of the bit array.

The above object is achieved by electronic paper displaying an image, including a liquid crystal display element according to the above invention.

According to the invention, a driving voltage and a pulse width of the voltage are varied at each step for displaying gray levels by utilizing cumulative response characteristics of a liquid crystal. Specifically, there is provided a first step for changing the reflectance of a liquid crystal layer to a first reflectance value that is either of two predetermined reflectance values to obtain a first gray level and a second step for changing the reflectance of the liquid crystal layer to a second reflectance value lower than the first reflectance value to obtain a second gray level lower than the first gray level. Thus, driving voltages can be kept low to allow the use of inexpensive general-purpose drivers providing binary output and having a low withstand voltage.

At the second step, a region having great margins of intermediate gray levels (the intermediate gray level region A in FIG. 4) is used. Therefore, high quality multi-level display can be achieved with quite small granularity.

The amount of data required for displaying an image can be minimized even when the number of gray levels is increased.

### BRIEF DESCRIPTION OF THE DRAWINGS

FIG. 1 is an illustration showing a schematic configuration of a liquid crystal display element 1 according to an embodiment of the invention;

FIG. 2 is a schematic view of a sectional configuration of the liquid crystal display element 1 according to the embodiment of the invention;

FIG. 3 is a graph showing examples of reflection spectra of the liquid crystal display element in the planar state;

FIG. 4 is a graph showing an example of voltage-reflectance characteristics of a cholesteric liquid crystal;

FIG. 5 is illustrations showing an example of a multi-level display operation for displaying eight gray levels according to the embodiment of the invention;

FIG. 6A shows voltage values and pulse widths of pulse voltages applied between electrodes 17 and 19 to set a first reflectance of a cholesteric liquid crystal at a first or second predetermined reflectance value;

FIG. 6B is a graph similar to FIG. 4 showing voltage-reflectance characteristics of a cholesteric liquid crystal and characteristics observed when pulse voltages having a pulse width of 4.0 ms are applied;

FIGS. 7A and 7B show examples of driving waveforms for driving the liquid crystal display element 1 according to the embodiment of the invention at a first step of driving;

FIGS. 8A and 8B show examples of driving waveforms for driving the liquid crystal display element 1 according to the embodiment of the invention at a second step of driving;

FIG. 9A shows voltage values and pulse widths of pulse voltages applied between the electrodes 17 and 19 at sub-step S1 of the second step;

FIG. 9B is a graph in which a curve P2 in a solid line represents characteristics observed when pulse voltages having a pulse width of 2.0 ms are applied, the graph also showing the curve P1 (pulse width: 4.0 ms) in FIG. 6B in a broken line for comparison;

FIG. 10A shows voltage values and pulse widths of pulse voltages applied between the electrodes 17 and 19 at sub-step S2 of the second step;

FIG. 10B is a graph in which a curve P3 in a solid line represents characteristics observed when pulse voltages having a pulse width of 1.0 ms are applied, the graph also showing the curve P1 (pulse width: 4.0 ms) in FIG. 6B in a broken line for comparison;

FIG. 11 shows a process of displaying level “7 (blue)” of a multi-level display method according to the embodiment of the invention;

FIG. 12 shows a process of displaying level “6” of the multi-level display method according to the embodiment of the invention;

FIG. 13 shows a process of displaying level “5” of the multi-level display method according to the embodiment of the invention;

FIG. 14 shows a process of displaying level “4” of the multi-level display method according to the embodiment of the invention;

FIG. 15 shows a process of displaying level “3” of the multi-level display method according to the embodiment of the invention;

FIG. 16 shows a process of displaying level “2” of the multi-level display method according to the embodiment of the invention;

FIG. 17 shows a process of displaying level “1” of the multi-level display method according to the embodiment of the invention;

FIG. 18 shows a process of displaying level “0 (black)” of the multi-level display method according to the embodiment of the invention;

FIG. 19 is an illustration showing an example of a driving method which allows hysteresis to be eliminated with scanning speed kept relatively high when carrying out the multi-level display method according to the embodiment of the invention;

FIG. 20 is a diagram showing the example of a driving method which allows hysteresis to be eliminated with scanning speed kept relatively high when carrying out the multi-level display method according to the embodiment of the invention;

FIG. 21 is a diagram showing the example of a driving method which allows hysteresis to be eliminated with scanning speed kept relatively high when carrying out the multi-level display method according to the embodiment of the invention;

FIG. 22 is a diagram showing a driving method used for performing first to n-th sub-steps of the second step in one scan when carrying out the multi-level display method according to the embodiment of the invention;

FIG. 23 is illustrations for explaining a process of generating image data of low gray levels for driving the display element from image data of higher gray levels when carrying out the multi-level display method according to the embodiment of the invention;

FIG. 24 is an illustration for explaining an example of a control circuit section 23 of the liquid crystal display element 1 according to the embodiment of the invention;

FIG. 25 is an illustration schematically showing a sectional configuration of a liquid crystal display element capable of full-color display according to the related art;

FIGS. 26A and 26B are illustrations schematically showing a sectional configuration of one liquid crystal layer of a liquid crystal display element according to the related art; and

FIGS. 27A, 27B, and 27C are illustrations showing a problem in driving according to the PWM method used in a liquid crystal display element according to the related art.

### DESCRIPTION OF EMBODIMENTS

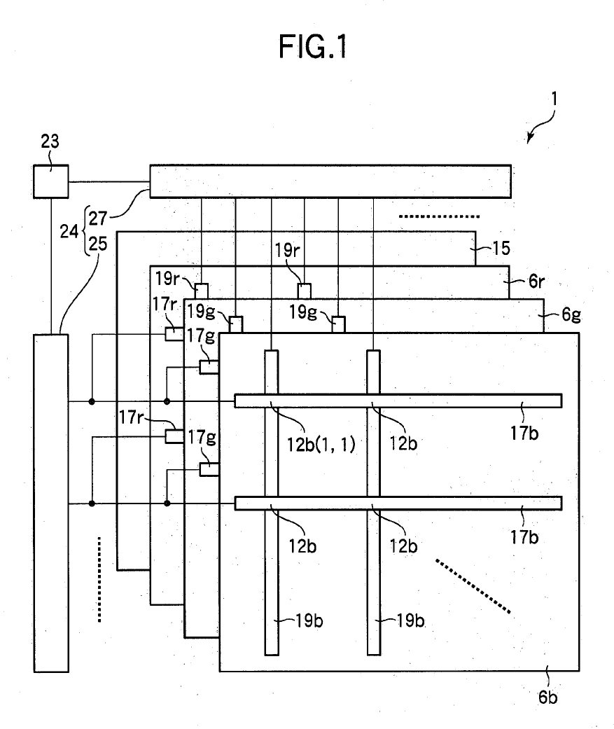

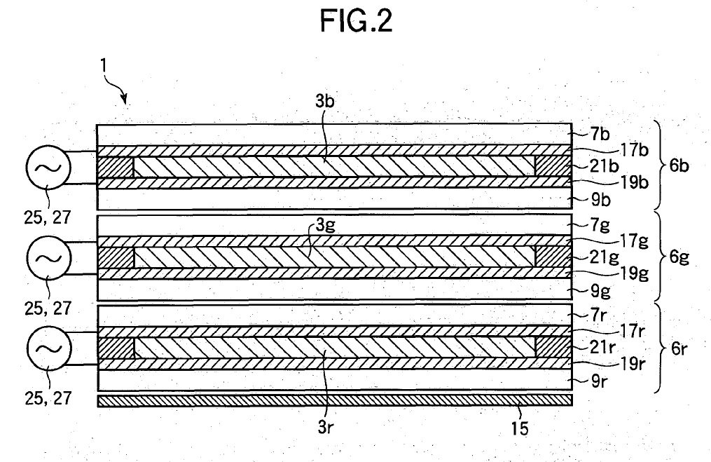

A liquid crystal display element, a method of driving the element, and electronic paper having the element according to an embodiment of the invention will now be described with reference to FIGS. 1 to 24. A liquid crystal display element 1 utilizing cholesteric liquid crystals for blue (B), green (G), and red (R) will be described as an example of an embodiment of the invention. FIG. 1 shows a schematic configuration of the liquid crystal display element 1 of the present embodiment. FIG. 2 is a schematic view of a sectional configuration of the liquid crystal display element 1 taken along a straight line extending in parallel with the horizontal direction of FIG. 1.

As shown in FIGS. 1 and 2, the liquid crystal display element 1 includes a B display portion (first display portion) 6b for selectively reflecting blue (B) light as a selected wave band in the planar state, a G display portion (second display portion) 6g for selectively reflecting green (G) light as another selected wave band in the planar state, and an R display portion (third display portion) 6r for selectively reflecting state. The B, G, and R display portions 6b, 6g, and 6r are formed one over another in the order listed starting from a side of the element where a light entrance surface (display surface) is provided.

The B display portion 6b includes a pair of substrates, i.e., a top substrate 7b and a bottom substrate 9b disposed to face each other and a B liquid crystal layer 3b enclosed between the substrates 7b and 9b. The B liquid crystal layer 3b is formed by a cholesteric liquid crystal which has right-handed optical rotatory power (right chirality) obtained by adjusting an average refractive index n and a helical pitch p of the layer to reflect blue light selectively. The liquid crystal reflects right-handed circularity polarized rays of blue light and transmits other types of light in the planar state and transmits substantially all types of light in the focal conic state.

The G display portion 6g includes a pair of substrates, i.e., a top substrate 7g and a bottom substrate 9g disposed to face each other and a G liquid crystal layer 3g enclosed between the substrates 7g and 9g. The G liquid crystal layer 3g is formed by a cholesteric liquid crystal which has left-handed optical rotatory power (left chirality) obtained by adjusting an average refractive index n and a helical pitch p of the layer to reflect green light selectively. The liquid crystal reflects left-handed circularity polarized rays of green light and transmits other types of light in the planar state and transmits substantially all types of light in the focal conic state.

The R display portion 6r includes a pair of substrates, i.e., a top substrate 7r and a bottom substrate 9r disposed to face each other and an R liquid crystal layer 3r enclosed between the substrates 7r and 9r. The R liquid crystal layer 3r is formed by a cholesteric liquid crystal which has right-handed optical rotatory power (right chirality) obtained by adjusting an average refractive index n and a helical pitch p of the layer to reflect red light selectively. The liquid crystal reflects right-handed circularity polarized rays of red light and transmits other types of light in the planar state and transmits substantially all types of light in the focal conic state.

The cholesteric liquid crystals constituting the B, G, and R liquid crystal layers 3b, 3g, and 3r are obtained by adding a chiral material to a nematic liquid crystal mixture in an amount to occupy 10 to 40 percent by weight. The chiral material content is a value on an assumption that the total amount of the nematic liquid crystal component and the chiral material corresponds to 100 percent by weight. Various types of known nematic liquid crystals may be used, but it is preferable to use a material having dielectric constant anisotropy Δ∈ satisfying an expression “20≦Δ∈≦50” in order to keep driving voltages for the liquid crystal layers 3b, 3g, and 3r relatively low. The cholesteric liquid crystals preferably have refractive index anisotropy satisfying an expression “0.18≦Δn≦0.24”. When the refractive index anisotropy Δn is smaller than this range, the liquid crystal layers 3b, 3g, and 3r have undesirably low reflectances in the planar state. When the refractive index anisotropy Δn is greater than this range, the liquid crystal layers 3b, 3g, and 3r have significant scattering reflections in the focal conic state. In addition, the layers will have high viscosity which will result in a reduced response speed.

The chiral materials added to the B and R cholesteric liquid crystals and the chiral material added to the G cholesteric liquid crystal are optical isomers that are different from each other in optical rotatory power. Thus, the B and R cholesteric liquid crystals are the same as each other and different from the G cholesteric liquid crystal in terms of optical rotatory power.

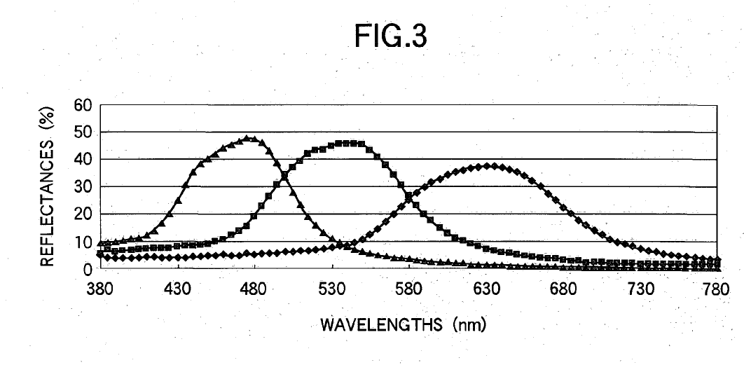

FIG. 3 shows examples of reflection spectra of the liquid crystal layers 3b, 3g, and 3r in the planar state. The abscissa axis represents wavelengths of reflected light, and the ordinate axis represents reflectances (in percentages in comparison to that of a white plate). The curve connecting the black triangular symbols in the figure represents a reflection spectrum observed at the B liquid crystal layer 3b. The curve connecting the black square symbols in the figure represents a reflection spectrum observed at the G liquid crystal layer 3g. The curve connecting the black rhombic symbols in the figure represents a reflection spectrum observed at the R liquid crystal layer 3r.

As shown in FIG. 3, center wavelengths of the reflection spectra of the liquid crystal layers 3b, 3g, and 3r in the planar state have magnitudes ascending in the order in which the layers are listed. In the multi-layer structure formed by the B, G, and R display portions 6b, 6g, and 6r, the optical rotatory power of the G liquid crystal layer 3g is different from the optical rotatory power of the B liquid crystal layer 3b and the R liquid crystal layer 3r in the planar state. Therefore, in the region where the blue and green reflection spectra overlap and the region where the green and red reflection spectra overlap as shown in FIG. 3, for example, right-handed circularly polarized rays of light can be reflected by the B liquid crystal layer 3b and the R liquid crystal layer 3r, and left-handed circularly polarized rays of light can be reflected by the G liquid crystal layer 3g. Thus, loss of reflected light can be reduced, and the liquid crystal display element 1 can be provided with a display surface having improved brightness.

The top substrates 7b, 7g, and 7r and the bottom substrates 9b, 9g, and 9r must be transparent. In the present embodiment, two film substrates cut to have longitudinal and transversal lengths of 10 (cm)×8 (cm) are used. The film substrates may be made from materials such as polyethyleneterephthalate (PET) or polycarbonate (PC). Film substrates made from those materials have sufficient flexibility. Glass substrates may be used instead of film substrates. Although the top substrates 7b, 7g, and 7r and the bottom substrates 9b, 9g, and 9r are all transparent in the present embodiment, the bottom substrate 9r of the R display portion 6r disposed to constitute the lowermost layer may be opaque.

As shown in FIGS. 1 and 2, a plurality of data electrodes 19b in the form of strips are formed in parallel on the side of the bottom substrate 9b of the B display portion 6b facing the B liquid crystal layer 3b, the electrodes extending in the vertical direction of FIG. 1. The symbol 19b in FIG. 2 represents a region where the plurality of data electrodes 19b exists. A plurality of scan electrodes 17b in the form of strips are formed in parallel on the side of the top substrate 7b of the B display portion 6b facing the B liquid crystal layer 3b, the electrodes extending in the horizontal direction of FIG. 1. As shown in FIG. 1, the plurality of scan electrodes 17b and data electrodes 19b are disposed in a face-to-face relationship such that they intersect each other when viewed in the normal direction of the surfaces of the top substrate 7b and the bottom substrate 9b where the electrodes are formed. In the present embodiment, transparent electrodes are patterned to form 240 scan electrodes 17b and 320 data electrodes 19b in the form of stripes having a pitch of 0.24 mm to allow QVGA display of 320×240 dots. Each of intersections between the electrodes 17b and 19b constitutes a B pixel 12b. A plurality of B pixels 12b are disposed in the form of a matrix having 240 rows and 320 columns.

Like the B display portion 6b, the G display portion 6g is formed with 240 scan electrodes 17g, 320 data electrodes 19g, and G pixels 12g (not shown) arranged in the form of a matrix having 240 rows and 320 columns. Similarly, the R display portion 6r is formed with scan electrodes 17g, data electrodes 19g, and R pixels 12r (not shown). One set of B, G, and R pixels 12b, 12g, and 12r constitutes one pixel 12 of the liquid crystal display element 1. Pixels 12 are arranged like a matrix to form a display screen.

For example, a typical material used to form the scan electrodes 17b, 17g, and 17r and the data electrodes 19b, 19g, and 19r is an indium tin oxide (ITO). Alternative materials include transparent conductive films made of an indium zinc oxide (IZO) or the like and transparent conductive films made of amorphous silicon or the like.

A scan electrode driving circuit 25 carrying scan electrode driver ICs for driving the plurality of scan electrodes 17b, 17g, and 17r is connected to the top substrates 7b, 7g, and 7r. A data electrode driving circuit 27 carrying data electrode driver ICs for driving the plurality of data electrodes 19b, 19g, and 19r is connected to the bottom substrates 9b, 9g, and 9r. A driving section 24 is formed by including the scan electrode driving circuit 25 and the data electrode driving circuit 27.

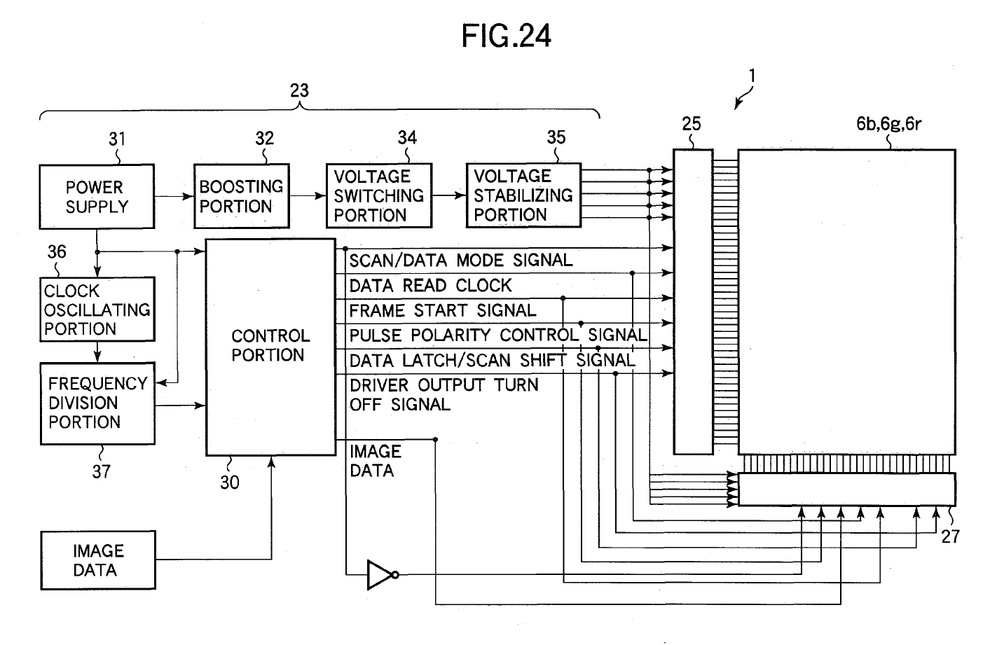

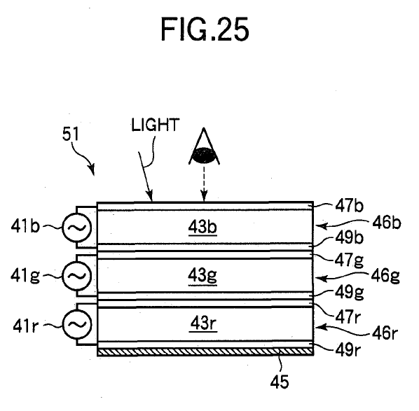

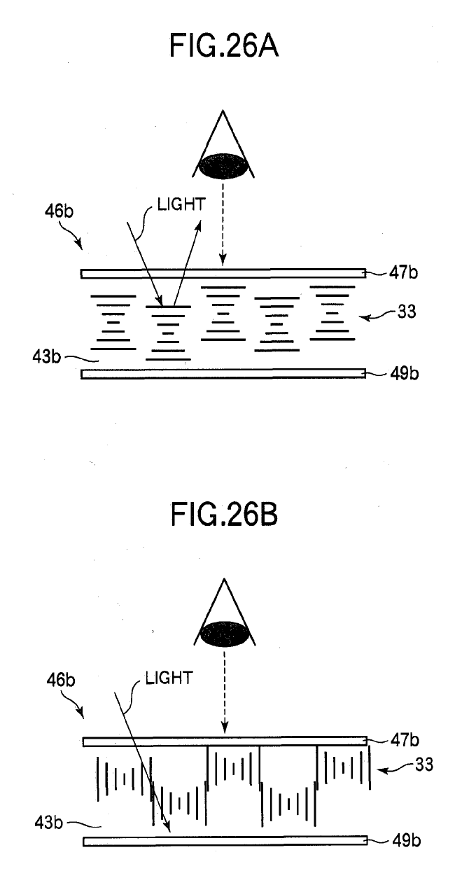

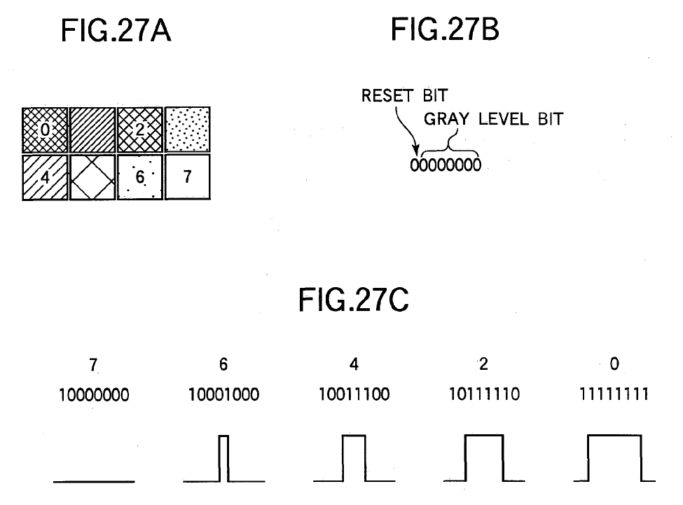

Based on a predetermined signal output from a control section 23, the scan electrode driving circuit 25 selects a predetermined set of three scan electrodes 17b, 17g, and 17r and simultaneously outputs a scan signal to the three scan electrodes 17b, 17g, and 17r. Based on a predetermined signal output from the control circuit section 23, the data electrode driving circuit 27 outputs image data signals for the B, G, and R pixels 12b, 12g, and 12r on the selected scan electrode 17b, 17g, and 17r to the respective data electrodes 19b, 19g, and 19r. For example, general-purpose STN driver ICs having a TCP (tape carrier package) structure are used as the scan electrode driver IC and the data electrode driver IC. The control circuit section 23 and the driving section 24 are included in a driving device which displays gray levels by performing a first step of obtaining a first gray level by changing the reflectance of a liquid crystal layer to a first reflection value equal to a first or second predetermined reflectance and a second step of obtaining a second gray level lower than the first gray level by changing the reflectance of the liquid crystal layer to a second reflectance value lower than the first reflectance value. Details of the configuration of the driving device including the control circuit section 23 will be described later with reference to FIG. 24.

In the present embodiment, since driving voltages for the B, G, and R liquid crystal layers 3b, 3g, and 3r can be made substantially equal to each other, a predetermined output terminal of the scan electrode driving circuit 25 is commonly connected to predetermined input terminals of scan electrodes 17b, 17g, and 17r. Thus, there is no need for providing a scan electrode driving circuit 25 for each of the B, G, and R display portions 6b, 6g, and 6r, and the configuration of driving circuit of the liquid crystal display element 1 can therefore be made simple. Since the number of scan electrode driver ICs required is small, the liquid crystal display element 1 can be manufactured at a low cost. The sharing of the output terminal of the scan electrode driving circuit 25 between B, G, and R display portions may be implemented as occasion demands.

Each of the electrodes 17b and 19b is preferably coated with a functional film, e.g., an insulation film or alignment film for controlling the alignment of liquid crystal molecules (neither of the films is shown). The insulation film has the function of preventing shorting between the electrodes 17b and 19b, and the film also serves as a gas barrier layer having the function of improving the reliability of the liquid crystal display element 1. A polyimide resin or an acryl resin may be used as the alignment film. In the present embodiment, for example, alignment films are applied throughout the substrates to coat the electrodes 17b and 19b. The alignment films may be also used as insulating thin films.

As shown in FIG. 2, the B liquid crystal layer 3b is enclosed between the substrates 7b and 9b by a seal material 21b applied to the peripheries of the top and bottom substrates 7b and 9b. The thickness (cell gap) d of the B liquid crystal layer 3b must be kept uniform. In order to maintain a predetermined cell gap d, spherical spacers made of a resin or inorganic oxide are dispersed in the B liquid crystal layer 3b. Alternatively, a plurality of columnar spacers coated with a thermoplastic resin on the surface thereof are formed in the B liquid crystal layer 3b. In the liquid crystal display element 1 of the present embodiment, spacers (not shown) are inserted in the B liquid crystal layer 3b to keep the cell gap d uniform. More preferably, a wall structure having adhesive properties may be formed to surround pixels. Preferably, the B liquid crystal layer 3b has a cell gap d in the range of 3 μm≦d≦6 μm. The liquid crystal layer 3b has an undesirably low reflectance in the planar state when the cell gap d is smaller than the range and requires an excessively high driving voltage when the cell gap d is greater than the range.

The structure of the G display portion 6g and the R display portion 6r will not be described because it is similar to that of the B display portion 6b. A visible light absorbing layer 15 is provided on the outer surface (bottom surface) of the bottom substrate 9r of the R display portion 6r. Since the visible light absorbing layer 15 is provided, rays of light which have not been reflected by the B, G, and R liquid crystal layers 3b, 3g, and 3r can be efficiently absorbed. Therefore, the liquid crystal display element 1 can display an image with a high contrast ratio. The visible light absorbing layer 15 may be provided as occasion demands.

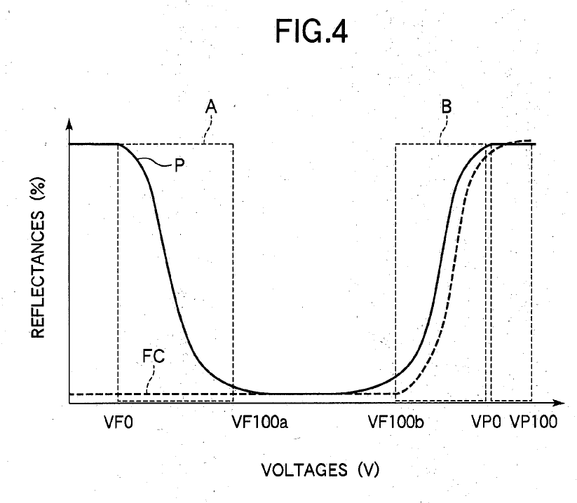

A multi-level display method implemented using the liquid crystal display element 1 of the present embodiment will now be described with reference to FIGS. 4 to 18. In the present embodiment, multi-level display is performed utilizing cumulative response properties of a cholesteric liquid crystal. Each time a pulse voltage having a predetermined voltage value is applied to a cholesteric liquid crystal, the liquid crystal can be gradually changed from the planar state to the focal conic state or from the focal conic state to the planar state because of the cumulative response properties.

FIG. 4 shows an example of voltage-reflectance characteristics of a common cholesteric liquid crystal. The abscissa axis represents voltage values (V) of pulse voltages having a predetermined pulse width (e.g., 4.0 ms) applied between electrodes 17 and 19 sandwiching the cholesteric liquid crystal, and the ordinate axis represents reflectances (%) of the cholesteric liquid crystal. The curve P in a solid line shown in FIG. 4 represents voltage-reflectance characteristics observed when the cholesteric liquid crystal is initially in the planar state, and the curve FC in a broken line represents voltage-reflectance characteristics observed when the cholesteric liquid crystal is initially in the focal conic state.

Referring to FIG. 4, when a predetermined high voltage VP100 (e.g., ±32 V) is applied between the electrodes 17 and 19 to generate a relatively strong electric field in the cholesteric liquid crystal, the helical structure of liquid crystal molecules is completely decomposed into a homeotropic state in which all liquid crystal molecules follow the direction of the electric field. When the applied voltage is abruptly decreased from the voltage VP100 to a predetermined lower voltage (e.g., a voltage VF0=±4 V) to make the electric field in the liquid crystal substantially zero while the liquid crystal molecules are in the homeotropic state, the liquid crystal molecules enter a helical state in which their helical axes are directed substantially perpendicular to the electrodes 17 and 19, and the liquid crystal therefore enters the planar state in which rays of light having a wavelength according to the helical pitch are selectively reflected.

When a predetermined low voltage VF100b (e.g., ±24 V) is applied between the electrodes 17 and 19 to generate a relatively weak electric field in the cholesteric liquid crystal, the cholesteric liquid crystal enters a state in which the helical structure of liquid crystal molecules is not completely decomposed. When the applied voltage is abruptly decreased from the voltage VF100b to the lower voltage VF0 to make the electric field in the liquid crystal substantially zero in this state, the liquid crystal molecules enter a helical state in which their helical axes are directed substantially parallel to the electrodes 17 and 19, and the liquid crystal therefore enters the focal conic state in which incident rays of light are transmitted. The cholesteric liquid crystal can be put in the focal conic state also by applying the high voltage VP100 to generate a strong electric field in the liquid crystal layer and by slowly removing the electric field thereafter.

Referring to the curve P shown in FIG. 4, in the frame A represented by a broken line, the reflectance of the cholesteric liquid crystal can be made lower, the higher the voltage value (V) of the pulse voltage applied between the electrodes 17 and 19. Referring to the curve P and curve FC shown in FIG. 4, in the frame B represented by a broken line, the reflectance of the cholesteric liquid crystal can be made lower, the lower the voltage value (V) of the pulse voltage applied between the electrodes 17 and 19. Hereinafter, the region in the frame A in a broken line will be referred to as “intermediate gray level region A” (first intermediate gray level region), and the region in the frame B in a broken line will be referred to as “intermediate gray level region B (second intermediate gray level region).

The voltage-reflectance characteristics of the cholesteric liquid crystal shown in FIG. 4 are obtained by keeping the pulse width of the applied pulse voltage constant. Alternatively, cumulative response properties of the cholesteric liquid crystal can be obtained by varying the pulse width of the pulse voltage. For example, let us assume that two types of pulse voltages having the same voltage value and different pulse widths are applied within the voltage range of the intermediate gray level region A. Then, the application of the pulse voltage having a relatively greater pulse width allows a greater reduction in reflectance than the application of the pulse voltage having a relatively smaller pulse width.

In the present embodiment, a multi-level display process has two steps, i.e., first and second steps. At the first step, a pulse voltage (first voltage) having a predetermined pulse width (first pulse width) is applied within the voltage range of the intermediate gray level region B to change the reflectance to a predetermined first reflectance. Then, the second step is performed using the voltage range of the intermediate gray level region A. At the second step, a pulse voltage having a pulse width smaller than the pulse width used at the first step is applied once or plural times, the pulse width decreasing each time the voltage is applied with the voltage value kept constant. The cumulative response properties of the cholesteric liquid crystal are utilized as thus described to decrease the reflectance of the same to a desired second reflectance gradually.

The present embodiment of the invention is a method of driving a liquid crystal display element for displaying gray levels by changing the reflectance of a liquid crystal layer, characterized in that it includes a first step of changing the reflectance of the liquid crystal layer to a first reflectance, which is either of two predetermined reflectance values, to obtain a first gray level and a second step of changing the reflectance of the liquid crystal layer to a second reflectance lower than the first reflectance to obtain a second gray level lower than the first gray level.

The multi-level display operation of the present embodiment will now be described with reference to FIG. 5 by explaining an example of display of eight gray levels. In order to show changes made to display gray levels with visual clarity, any of gray levels “0” to “7” is assigned to each of eight pixels arranged in the form of a matrix having two rows and four columns as will be apparent from the illustration on the right side of FIG. 5 showing a state obtained after a sub-step S2 is performed. The gray level “7” is a gray level obtained when a cholesteric liquid crystal in a pixel enters the planar state in which it has a high reflectance. The gray level “0” is a gray level obtained when the liquid crystal enters the focal conic state in which it has a low reflectance. Referring to the gray level of each of the eight pixels after sub-step S2, the pixels in the first to fourth columns of the first row have gray levels “0”, “1”, “2”, and “3”, respectively, and the pixels in the first to fourth columns of the second row have gray levels “4”, “5”, “6”, and “7”, respectively.

As shown on the left side of FIG. 5, at the first step (or step S1), the pixel region of the first row is an “OFF” group to which an OFF pulse is applied. Thus, the reflectance of the pixel region of the first row is thus changed to a first reflectance that is a second predetermined reflectance value resulting from substantially a half-and-half mixture of the planar and focal conic states. The pixel region of the second row is an “ON” group to which an “ON” pulse is applied, and the reflectance of the pixel region of the second row is thus changed to a first reflectance that is a first predetermined reflectance value resulting from a complete planar state. When the first predetermined reflectance value is 1 (= 8/8), the second predetermined reflectance value is ½ (= 4/8) because it is substantially one half of the first predetermined reflectance value. As thus described, at the first step, the reflectance of the liquid crystal layer is changed to first reflectances, which are either of two predetermined reflectance values (first and second predetermined reflectance values), to obtain first gray levels.

As a result, the first to fourth columns of the first row have a first gray level “3”, and the first to fourth columns of the second row have a first gray level “7”.

At the subsequent of second step, the reflectance of the four pixels in the first row is changed to low reflectances equal to or lower than the second predetermined reflectance values, and the reflectance of the four pixels in the second row is changed to reflectances between the first predetermined reflectance value and the second predetermined reflectance values.

At sub-step S1 of the second step, the pixel regions of the first and second columns are selected as an “ON” group to which an “ON” pulse is applied. Thus, the reflectances of the regions are decreased by ¼ of the reflectances the regions had when they belonged to an “ON” or “OFF” group. As a result, as apparent from the illustration showing a state after sub-step S1, the reflectance of the two pixels in the first and second columns of the first row is decreased by ¼ (= 2/8) of the first reflectance obtained at the first step (the second predetermined reflectance value). That is, the reflectance is decreased to 6/8. The reflectance of the two pixels in the first and second columns of the second row is decreased by ¼ (= 2/8) of the first reflectance obtained at the first step (the first predetermined reflectance value=½= 4/8). That is, the reflectance is decreased to 2/8. As a result, the first columns to the fourth columns of the first row have gray levels “1”, “1”, “3”, and “3”, respectively, and the first to fourth columns of the second row have gray levels “5”, “5”, “7”, and “7”, respectively.

At the subsequent step of sub-step S2, the pixel regions of the first and third columns are selected as an “ON” group to which an “ON” pulse is applied. Thus, the reflectances of the regions are decreased by ⅛ of the ref lectances the regions had when they belonged to an “ON” or “OFF” group. As a result, as apparent from the illustration showing a state after sub-step S2, the reflectances of the two pixels in the first and third columns of the first row are decreased by ⅛ of the ref lectances obtained at sub-step S1, and the reflectances of the two pixels in the first and third columns of the second row are also decreased by ⅛ of the reflectances obtained at sub-step S1. That is, the reflectance of the pixel in the first column of the first row is decreased to ⅛ which is ⅛ lower than 2/8, and the reflectance of the pixel in the third column of the first row is decreased to ⅜ which is ⅛ lower than 4/8. The reflectance of the pixel in the first column of the second row is decreased to ⅝ which is ⅛ lower than 6/8, and the reflectance of the pixel in the third column of the second row is decreased to ⅞ which is ⅛ lower than 8/8. As a result, all of the eight pixels have desired second reflectance values. The first to fourth columns of the first row have desired second gray levels “0”, “1”, “2”, and “3”, respectively, and the first to fourth columns of the second row have desired second gray levels “4”, “5”, “6”, and “7”, respectively.

The above-described process provides pixels in eight different states depending on where an “ON” pulse is applied at each step or not, the pixels including a pixel to which an “ON” pulse is applied at all of step S1, sub-step S1, and sub-step S2 and a pixel to which an “ON” pulse is not applied at any of the step S1, sub-step S1, and sub-step S2. Eight regions at different gray levels can be formed by varying the pulse voltage or pulse width of an “ON” pulse applied at each step. The above-described sequence makes it possible to display eight gray levels by applying a pulse three times using a general-purpose driver for binary writing.

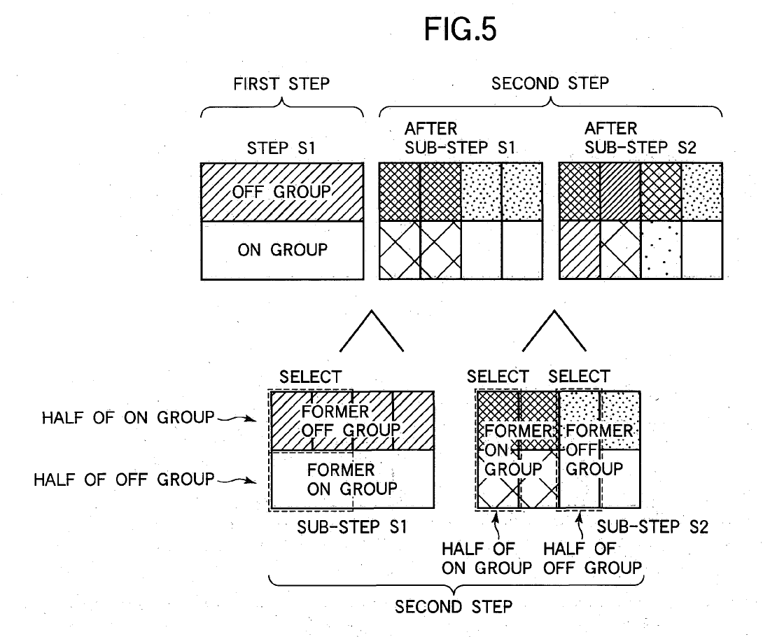

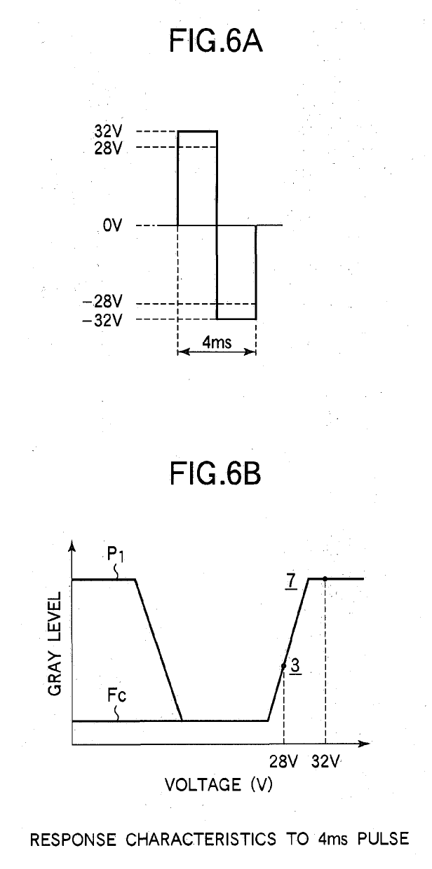

A method of driving the liquid crystal display element 1 will now be described with reference to FIGS. 6A to 18.

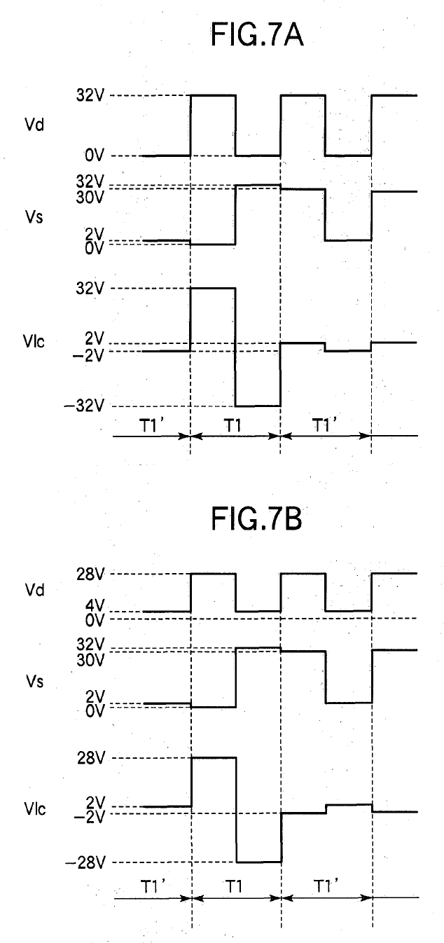

First, a description will now be made with reference to FIGS. 6A, 6B, 7A and 7B on how the first step is performed according to the driving method. FIG. 6A shows voltage values and pulse widths of pulse voltages applied between the electrodes 17 and 19 to set the first reflectance of the cholesteric liquid crystal at the first or second predetermined reflectance value. In this example, a pulse voltage having a pulse width of 4.0 ms and a voltage value of ±32 V is used to obtain the first predetermined reflectance value, and a pulse voltage having a pulse width of 4.0 ms and a voltage value of ±28 V is used to obtain the second predetermined reflectance value.

FIG. 6B is a graph similar to FIG. 4 showing voltage-reflectance characteristics of the cholesteric liquid crystal, and the graph shows characteristics observed when the pulse voltages having a pulse width of 4.0 ms are applied. The ordinate axis of FIG. 6B represents gray level values. The curve P1 shown in FIG. 6B represents voltage-reflectance characteristics observed when the cholesteric liquid crystal is initially in the planar state, and the curve FC represents voltage-reflectance characteristics observed when the cholesteric liquid crystal is initially in the focal conic state. As shown in FIG. 6B, the pulse voltage having a pulse width of 4.0 ms and a voltage value of ±32 V is applied to draw either curve P1 or FC in the voltage range of an intermediate gray level region B as described with reference to FIG. 4. Thus, the first reflectance can be set at the first predetermined reflectance value to obtain a first gray level “7 (white)”. Similarly, the pulse voltage having a pulse width of 4.0 ms and a voltage value of ±28 V is applied to draw either curve P1 or FC. Thus, the first reflectance can be set at the second predetermined reflectance value to obtain a first gray level “3”.

FIGS. 7A and 7B show examples of driving waveforms used at the first step to drive the liquid crystal display element 1. FIG. 7A shows driving waveforms for setting the cholesteric liquid crystal at the first predetermined reflectance value representing the planar state, and FIG. 7B shows driving waveforms for setting the cholesteric liquid crystal at the second predetermined reflectance value that is substantially one half of the first predetermined reflectance value. In each of FIGS. 7A and 7B, a data signal voltage waveform Vd output from the data electrode driving circuit 27 is shown in the top part; a scan signal voltage waveform Vs output from the scan electrode driving circuit 25 is shown in the middle part; and an applied voltage waveform V1c applied to any of pixels 12b, 12g, and 12r of the B, G, and R liquid crystal layers 3b, 3g, and 3r is shown in the bottom part. In FIGS. 7A and 7B, time is shown to lapse in the left-to-right direction in the figures, and voltages are represented in the vertical direction of the figures.

An example will now be described, in which a predetermined voltage is applied to a blue (B) pixel 12b (1,1) that is located at the intersection between the data electrode 19b in the first column of the B display portion 6b shown in FIG. 1 and the scan electrode 17b in the first row. As shown in FIG. 7A, in the first half of a selection period T1 during which the scan electrode 17b in the first row is selected, the data signal voltage Vd is ±32 V, whereas the scan signal voltage Vs is 0 V. In the second half of the period, the data signal voltage Vd is 0 V, whereas the scan signal voltage Vs is ±32V. Therefore, a pulse voltage of ±32 V is applied to the B liquid crystal layer 3b at the B pixel 12b (1,1) during the selection period T1 (4.0 ms). When a predetermined high voltage (32 V) is applied to the cholesteric liquid crystal to generate a strong electric field therein, the helical structure of liquid crystal molecules is completely decomposed into a homeotropic state in which all liquid crystal molecules follow the direction of the electric field. Therefore, the liquid crystal molecules in the B liquid crystal layer 3b at the B pixel 12b (1,1) are in the homeotropic state during the selection period T1.

When the selection period T1 ends and a non-selection period T1′ starts, voltages of, for example, +30 V and +2 V having a period equivalent to one half of the selection period T1 are applied to the scan electrode 17b in the first row. On the other hand, predetermined data signal voltages Vd are applied to the data electrode 19b in the first column. In FIG. 7A, voltages of, for example, +32 V and 0 V having a period equivalent to one half of the non-selection period T1′ are applied to the data electrode 19b in the first column. Therefore, a pulse voltage of ±2 V is applied to the B liquid crystal layer 3b at the B pixel 12b (1,1) during the non-selection period T1′. As a result, the electric field generated in the B liquid crystal layer 3b at the B pixel 12b (1,1) during the non-selection period T1′ is made substantially zero.

When the voltage applied to the liquid crystal changes from ±32 V to ±2 V to make the electric field substantially zero abruptly with the liquid crystal molecules in the homeotropic state, the liquid crystal molecules enter a helical state in which the helical axes are directed substantially perpendicular to the electrodes 17b and 19b. Thus, the liquid crystal enters the planar state, in which rays of light in accordance with the helical pitch are selectively reflected.

Since the B liquid crystal layer 3b at the B pixel 12b (1,1) thus enters the planar state to reflect light, the first reflectance of the B pixel 12b (1,1) is set at the first predetermined reflectance value to display a first gray level “7”.

As shown in FIG. 7B, in the first half of the selection period T1 and in the second half of the period, the data signal voltage Vd is 28 V and 4 V, respectively, whereas the scan signal voltage Vs is 0 V and +32 V, respectively. Then, a pulse voltage of ±28 V is applied to the B liquid crystal layer 3b at the B pixel 12b (1,1). When a predetermined low voltage (28 V) is applied to the cholesteric liquid crystal to generate a weak electric field therein, the helical structure of the liquid crystal molecules is not completely decomposed. In the non-selection period T1′, for example, voltages of +30 V and +2 V having a period equivalent to one half of the non-selection period T1′ are applied to the scan electrode 17b in the first row, and predetermined data signal voltages Vd (+28 V and 4 V) having a period equivalent to one half of the non-selection period T1′ are applied to the data electrode 19b. Thus, a pulse voltage of ±2 V is applied to the B liquid crystal layer 3b at the B pixel 12b (1,1) during the non-selection period T1′. As a result, the electric field generated in the B liquid crystal layer 3b at the B pixel 12b (1,1) is made substantially zero during the non-selection period T1′.

When the voltage applied to the cholesteric liquid crystal changes from ±24 V to ±2 V to make the electric field substantially zero abruptly in the state in which the helical structure of the liquid crystal molecules is not completely decomposed, the liquid crystal has the second predetermined reflectance value resulting from a state that is substantially a half-and-half mixture of the planar state and the focal conic state. Thus, the B liquid crystal layer 3b at the B pixel 12b (1,1) reflects light in the state that is substantially a half-and-half mixture of the planar state and the focal conic state. Therefore, at the first step, the first reflectance of the B pixel 12b (1,1) is set at the second predetermined reflectance value to display a first gray level “3”. The use of an alternating positive/negative pulse to drive a liquid crystal is a normal practice carried out for purposes such as prevention of deterioration of a liquid crystal.

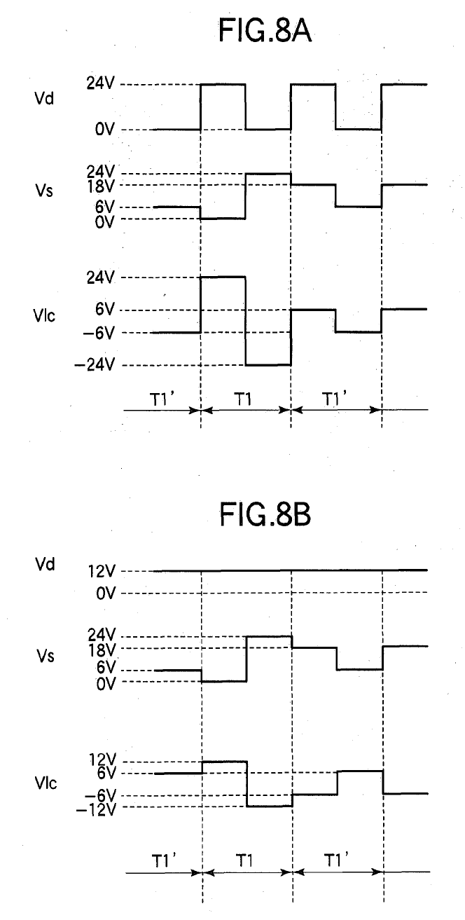

A description will now be made with reference to FIGS. 8A to 10B on how the second step is performed according to the driving method.

FIGS. 8A and 8B show examples of driving waveforms used at the second step to driving the liquid crystal display element 1. FIG. 8A shows driving waveforms (ON pulses) for decreasing the reflectance of the cholesteric liquid crystal, and FIG. 8B shows driving waveforms (OFF pulses) for maintaining the reflectance of the cholesteric liquid crystal as it is. The definitions given for FIGS. 7A and 7B hold true for the ordinate and the abscissa axes of FIGS. 8A and 8B and periods shown in the figures.

As shown in FIG. 8A, in the first half occupying substantially one half of a selection period T1 during which the scan electrode 17b in the first row is selected, the data signal voltage Vd is +24 V, whereas the scan signal voltage Vs is 0 V. In the second half of the period, the data signal voltage is 0 V, whereas the scan signal voltage is +24 V. Thus, a pulse voltage (ON pulse) of ±24 V is applied to the B liquid crystal layer 3b at the B pixel 12b (1,1) during the selection period T1 (e.g., 2.0 ms).

At the second step, the scanning speed of the scan electrode 17b is higher than that of the first step, and the selection period (pulse width) T1 is 2.0 ms which is shorter than the selection period of 4.0 ms at the first step. Alternatively, the horizontal scan period may be set at a maximum value (e.g., 4.0 ms), and a shorter pulse voltage width may be used in such a scan period.

When a predetermined low voltage (=24 V) is applied to the cholesteric liquid crystal to generate a weak electric field therein, the helical structure of the liquid crystal molecules is not completely decomposed. In a non-selection period T1′, for example, voltages of +18 V and +6 V having a period equivalent to one half of the non-selection period T1′ are applied to the scan electrode 17b in the first row, and predetermined data signal voltages Vd (+24 V and 0 V) having a period equivalent to one half of the non-selection period T1′ are applied to the data electrode 19b. Thus, a pulse voltage of ±6 V is applied to the B liquid crystal layer 3b at the B pixel 12b (1,1) during the non-selection period T1′. As a result, the electric field generated in the B liquid crystal layer 3b at the B pixel 12b (1,1) is made substantially zero during the non-selection period T1′.

When the voltage applied to the cholesteric liquid crystal abruptly changes from ±24 V to ±6 V in the state in which the helical structure of the liquid crystal molecules is not completely decomposed, the liquid crystal enters an intermediate state that is a mixture of the planar state and the focal conic state. Thus, the B liquid crystal layer 3b at the B pixel 12b (1,1) reflects light in the intermediate state that is a mixture of the planar state and the focal conic state. Therefore, at the second step, a second reflectance having a value lower than the first or second predetermined reflectance value can be obtained at the B pixel 12b (1,1) when an ON pulse is applied.

As shown in FIG. 8B, in the first half and second half of the selection period T1, the data signal voltage Vd is +12 V and +12 V, respectively, whereas the scan signal voltage Vs is 0 V and +24 V, respectively. Then, a pulse voltage (OFF pulse) of ±12 V is applied to the B liquid crystal layer 3b at the B pixel 12b (1,1). When a predetermined low voltage (=12 V) is applied to the cholesteric liquid crystal, although a very weak electric field is generated, the state of liquid crystal molecules is maintained without no noticeable change. When the non-selection period T1′ comes, for example, voltages of +8 V and +6 V having a period equivalent to one half of the non-selection period T1′ are applied to the scan electrode 17b in the first row, and predetermined data signal voltages Vd (+12 V and +12 V) having a period equivalent to one half of the non-selection period T1′ are applied to the data electrode 19b. Thus, a pulse voltage of ±6 V is applied to the B liquid crystal layer 3b at the B pixel 12b (1,1) during the non-selection period T1′. Thus, no significant change occurs in the electric field generated in the B liquid crystal layer 3b at the B pixel 12b (1,1) during the non-selection period T1′. As a result, since the state of liquid crystal molecules is kept unchanged, there is no change in reflectance when an OFF pulse is applied.

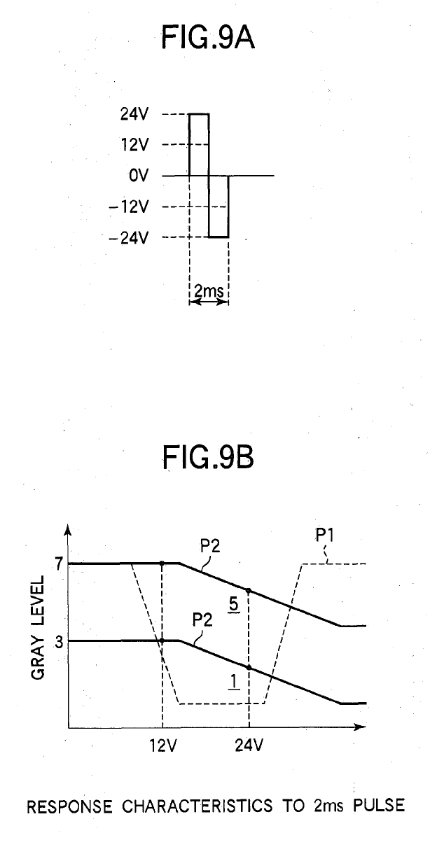

FIG. 9A shows voltage values and pulse widths of pulse voltages applied between the electrodes 17 and 19 at sub-step S1 of the second step. In this example, a pulse voltage having a pulse width of 2.0 ms and a voltage value of ±24 V is used as an ON pulse, and a pulse voltage having a pulse width of 2.0 ms and a voltage value of ±12 V is used as an OFF pulse.

In FIG. 9B, the curve P2 in a solid line represents characteristics observed when the pulse voltages having a pulse width of 2.0 ms are applied, and the curve P1 (pulse width: 4.0 ms) in FIG. 6B is shown in a broken line for comparison. When the scanning speed of the scan electrode 17b is increased from 4.0 ms/line to 2.0 ms/line, the curve P2 representing response characteristics is shifted to the right with respect to the curve P1. Therefore, as shown in FIG. 9B, at sub-step S1, a reflectance resulting in a gray level reduction of two steps can be obtained by applying the ON pulse shown in FIG. 9A in the voltage range of the intermediate gray level region A of the curve P2. For example, sub-step S1 is performed on pixels of interest which have been set at a first gray level “7” or “3” at step S1. Specifically, the ON and OFF pulses shown in FIG. 9A are applied to “ON” pixels and “OFF” pixels, respectively. Then, the gray levels of the “ON” pixels change from “7” and “3” to “5” and “1”, respectively. On the contrary, there is no change in the gray levels of the “OFF” pixels, and the gray level “7” or “3” is kept unchanged.

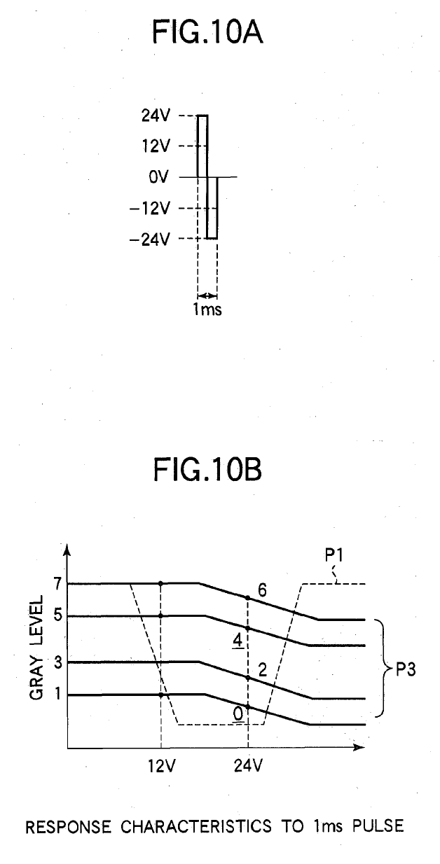

FIG. 10A shows voltage values and pulse widths of pulse voltages applied between the electrodes 17 and 19 at sub-step S2 of the second step. In this example, a pulse voltage having a pulse width of 1.0 ms and a voltage value of ±24 V is used as an ON pulse, and a pulse voltage having a pulse width of 1.0 ms and a voltage value of ±12 V is used as an OFF pulse.

In FIG. 10B, the curve P3 in a solid line represents characteristics observed when the pulse voltages having a pulse width of 1.0 ms are applied, and the curve P1 (pulse width: 4.0 ms) in FIG. 6B is shown in a broken line for comparison. When the scanning speed of the scan electrode 17b is increased from 2.0 ms/line to 1.0 ms/line, the curve P3 representing response characteristics is shifted further to the right with respect to the curve P1. Therefore, as shown in FIG. 10B, at sub-step S2, a reflectance resulting in a gray level reduction of one step can be obtained by applying the ON pulse shown in FIG. 10A in the voltage range of the intermediate gray level region A of the curve P3.

For example, sub-step S2 is performed on pixels of interest which have been set at the gray level “5” or “1” at sub-step S1. Specifically, the ON and OFF pulses shown in FIG. 10A are applied to “ON” pixels and “OFF” pixels, respectively. Then, the gray levels of the “ON” pixels change from “5” and “1” to desired second gray levels “4” and “0”, respectively. On the contrary, there is no change in the gray levels of the “OFF” pixels, and the gray level “5” or “1” is kept unchanged.

For example, the sub-step S2 may alternatively be performed on pixels of interest which have been set at the gray levels “7” or “3” at the sub-step S1. Specifically, the ON and OFF pulses shown in FIG. 10A are applied to “ON” pixels and “OFF” pixels, respectively. Then, the gray levels of the “ON” pixels change from “7” and “3” to desired second gray levels “6” and “2”, respectively. On the contrary, there is no change in the gray levels of the “OFF” pixels, and the gray level “7” or “3” is kept unchanged.

Response characteristics relative to scanning speeds (ms/line) as shown FIGS. 9B and 10B depend on the liquid crystal material and element structure employed, and the characteristics shown in the examples should not be taken in a limiting sense.

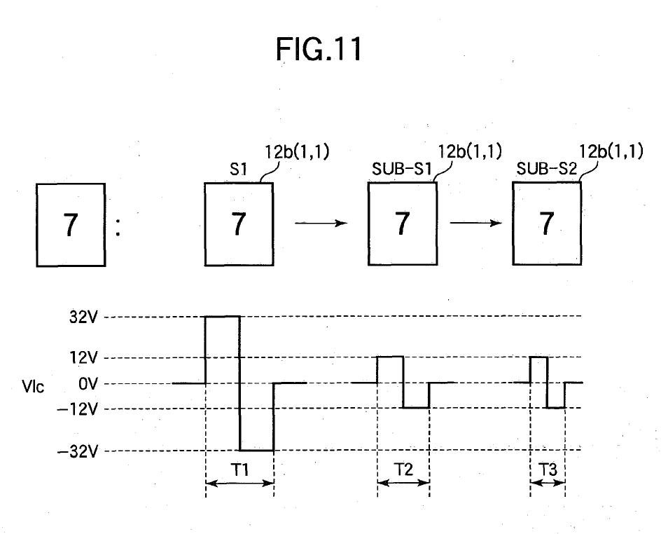

The multi-level display operations of the present embodiment will now be described on a time-sequential basis with reference to FIGS. 11 to 18 specifically showing the operations. The following description shows an example in which any of eight gray levels “7 (blue)” to “0 (black)” is displayed at the blue (B) pixel 12b (1,1).

The rectangle shown at the top left end of each of FIGS. 11 to 18 is a schematic illustration of the outline of the B pixel 12b (1,1), and the number shown in the rectangle represents a desired gray level. On the right side of the leftmost rectangle, steps of a cumulative response process to obtain the desired gray level at the B pixel 12b (1,1) are represented by arrows indicating a time series and numbers indicating changes in the gray level displayed at the pixel. In the lower part of each of the figures, a pulse voltage V1c applied to the B pixel 12b (1,1) in a section period at each step of the cumulative response process is shown. A pulse voltage applied during in a non-selection period is omitted.

As illustrated, the present embodiment includes the first step utilizing the intermediate gray level region B shown in FIG. 6B and the second step utilizing the intermediate gray level region A shown in FIGS. 9B and 10B. At the first step, step S1 is performed. At the second step, a cumulative response process is performed at sub-step S1 (SUB-S1 in FIGS.) and sub-step S2 (SUB-S2 in FIGS.)

As shown in FIGS. 11 to 14, when gray level “7” and any of gray levels “6” to “4” (intermediate gray levels) are desired, a pulse voltage V1c of ±32 V is applied using the intermediate gray level region B shown in FIG. 6B at step S1. As a result, the cholesteric liquid crystal can be put in the planar state (a first gray level 7) in preparation to an operation of obtaining any of gray levels “6” to “4” utilizing cumulative response in the intermediate gray level region A shown in FIGS. 9B and 10B.

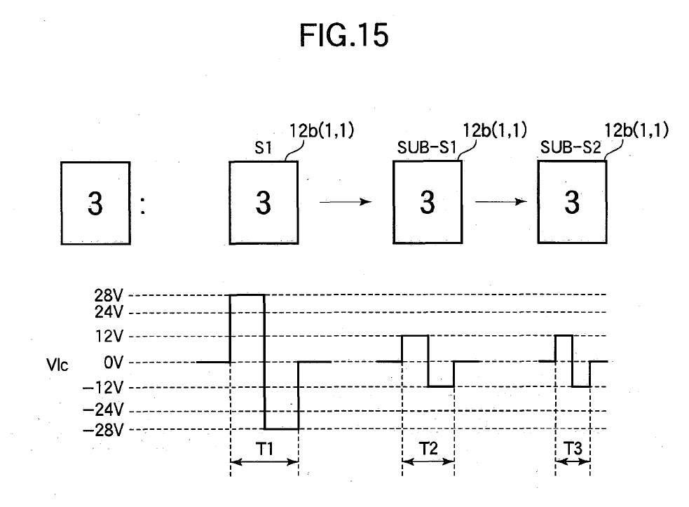

As shown in FIGS. 15 to 18, when any of gray levels “3” to “1” (intermediate gray levels) and gray level “0” are desired, a pulse voltage V1c of ±28 V is applied using the intermediate gray level region B shown in FIG. 6B at step S1. As a result, the cholesteric liquid crystal can be set at a first gray level “3” in preparation to an operation of obtaining any of gray levels “2” to “0” utilizing cumulative response in the intermediate gray level region A shown in FIGS. 9B and 10B.

At the subsequent step, i.e., the sub-steps S1 and S2 of second step, a predetermined pulse voltage V1c is applied for predetermined application periods (selection periods) T2 and T3. As shown in FIGS. 11 to 14, sub-steps S1 and S2 involve the application of a pulse voltage V1c having a voltage value and an application period acting in the direction of changing the cholesteric liquid crystal from the planar state to the focal conic state or the direction of decreasing the reflectance of the cholesteric liquid crystal utilizing cumulative response in the intermediate gray level region A. The sub-steps also involve the application of a pulse voltage V1c having a voltage value and an application period keeping the state of the cholesteric liquid crystal unchanged. In this example, a voltage value of ±24 V is used as the voltage for changing the cholesteric liquid crystal from the planar state to the focal conic state, as shown in FIGS. 9A and 10A. A voltage value of ±12 V is used as the voltage for keeping the state of the cholesteric liquid crystal unchanged.

Further, at sub-steps S1 and S2, pulse voltage application periods T2 and T3 have different durations. As already described, the state of a cholesteric liquid crystal can be changed not only by changing the value of a pulse voltage applied to the same but also by changing the pulse width. In the intermediate gray level region A shown in FIG. 4, a transition of the cholesteric liquid crystal toward the focal conic state can be caused even when a pulse voltage applied has a relatively great pulse width. In this example, a pulse voltage application period T2 at sub-step S1 is 2.0 ms, and a pulse voltage application period T3 at sub-step S2 is 1.0 ms.

The pulse voltage application periods T1, T2, and T3 can be controlled by decreasing the frequency of the clock for driving the scan electrode driving circuit 25 and the data electrode driving circuit 27 to increase the output period. Pulse width switching can be carried out with higher stability by changing the frequency division ratio of a clock generating section providing a logical input of a clock frequency to the drivers than switching the clock frequency itself on an analog basis.

Thus, at sub-steps S1 and S2, two pulse voltage values ±24 V and ±12 V and two pulse widths 2.0 ms and 1.0 ms, which are contiguous in the time series, are combined to obtain four (2²) driving patterns. Eight (2³) driving patterns are obtained in total at step S1, sub-step S1, and sub-step S2. Table 1 is a list of driving patterns as thus described. Table 1 shows pulse widths (application periods (ms)) of pulse voltages applied to the B pixel 12b (1,1) at step S1, sub-step S1, and sub-step S2. The table also shows the voltage value (V) of a pulse voltage applied to obtain each of levels from “7 (blue)” to “0 (black) at step S1, sub-step S1, and sub-step S2.

TABLE 1

Steps

| | S1 | SUB-S1 | SUB-S2 |
|---|---|---|---|
| App. Period (ms) | 4.0 | 2.0 | 1.0 |
| Level 7 (V) | ±32 (on: 1) | ±12 (off: 0) | ±12 (off: 0) |
| Level 6 | ±32 (on: 1) | ±12 (off: 0) | ±24 (on: 1) |
| Level 5 | ±32 (on: 1) | ±24 (on: 1) | ±12 (off: 0) |
| Level 4 | ±32 (on: 1) | ±24 (on: 1) | ±24 (on: 1) |
| Level 3 | ±28 (off: 0) | ±12 (off: 0) | ±12 (off: 0) |
| Level 2 | ±28 (off: 0) | ±12 (off: 0) | ±24 (on: 1) |
| Level 1 | ±28 (off: 0) | ±24 (on: 1) | ±12 (off: 0) |
| Level 0 | ±28 (off: 0) | ±24 (on: 1) | ±24 (on: 1) |

In order to display gray level “7 (blue) (second gray level) at the B pixel 12b (1,1), as shown in Table 1 and FIG. 11, a pulse voltage V1c of ±32 V is first applied at step S1 to put the cholesteric liquid crystal in the planar state (level “7” (first gray level). Then, a pulse voltage V1c of +12 V is applied at sub-steps S1 and S2 to keep the state of the liquid crystal unchanged, and gray level “7” is therefore displayed.

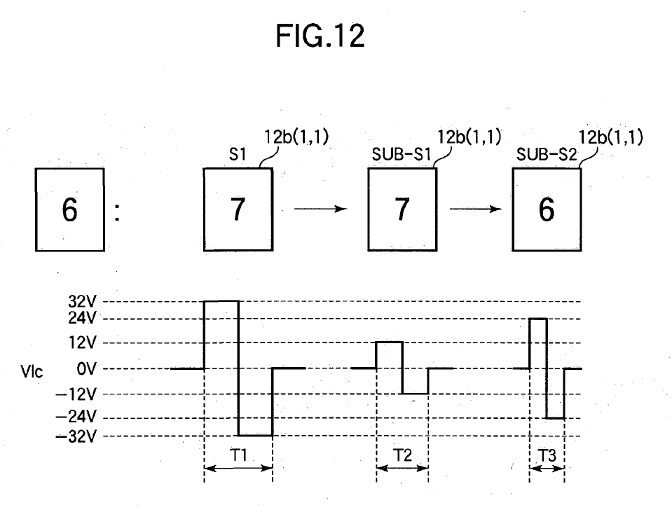

In order to display gray level “6” at the B pixel 12b (1,1), as shown in Table 1 and FIG. 12, a pulse voltage V1c of ±32 V is first applied at step S1 to put the cholesteric liquid crystal in the planar state (level “7”). Then, a pulse voltage V1c of ±12 V is applied at sub-step S1 to keep the state of the liquid crystal at level “7” at sub-step S1. At sub-step S2, a pulse voltage V1c of ±24 V is applied to the cholesteric liquid crystal for 1.0 ms to change the state of the same toward the focal conic state by a predetermined amount. Thus, the gray level is lowered one step to gray level “6”.

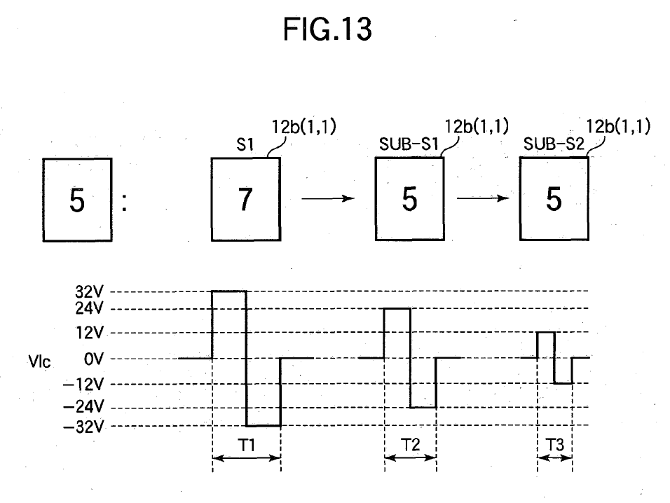

In order to display gray level “5” at the B pixel 12b (1,1), as shown in Table 1 and FIG. 13, a pulse voltage V1c of ±32 V is first applied at step S1 to put the cholesteric liquid crystal in the planar state (level “7”). Then, a pulse voltage V1c of ±24 V is applied to the cholesteric liquid crystal for 2.0 ms at sub-step S1 to change the state of the same toward the focal conic state by a predetermined amount. The duration of the pulse voltage V1c of ±24 V applied at sub-step S1 is twice the duration of the same voltage applied at sub-step S2. Thus, the gray level is lowered one further step from level “6” shown in FIG. 12 to obtain gray level “5”. At sub-step S2, the pulse voltage V1c of ±12 V is applied to keep the state level “5”.

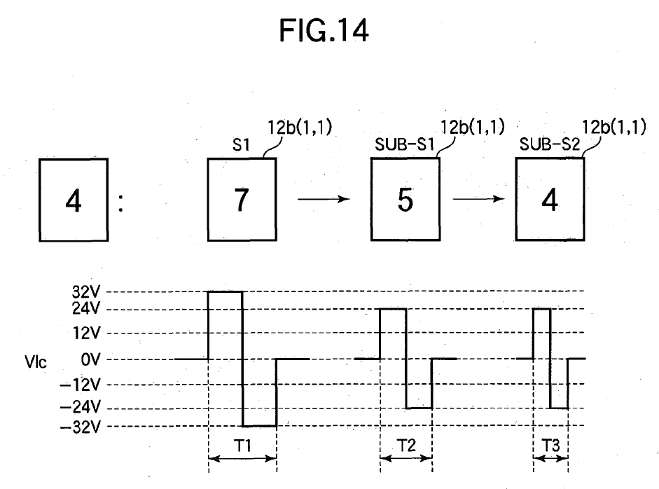

In order to display gray level “4” at the B pixel 12b (1,1), as shown in Table 1 and FIG. 14, a pulse voltage V1c of ±32 V is first applied at step S1 to put the cholesteric liquid crystal in the planar state (level “7”). Then, a pulse voltage V1c of ±24 V is applied to the cholesteric liquid crystal for 2.0 ms at sub-step S1 to lower the gray level two steps, whereby gray level “5” is obtained. At sub-step S2, a pulse voltage V1c of ±24 V is further applied for 1.0 ms to cause a transition of the cholesteric liquid crystal toward the focal conic state further. Thus, gray level “4” that is one step lower than level “5” is obtained.

In order to display gray level “3” at the B pixel 12b (1,1), as shown in Table 1 and FIG. 15, a pulse voltage V1c of ±28 V is first applied at step S1 for a period of 4.0 ms. As a result, the cholesteric liquid crystal undergoes a transition from the previous state of alignment, and gray level “3” is obtained. Since gray level “3” is obtained at step S1, a pulse voltage V1c of ±12 V for keeping the state of the liquid crystal unchanged is applied at sub-steps S1 and S2 to display gray level “3”.

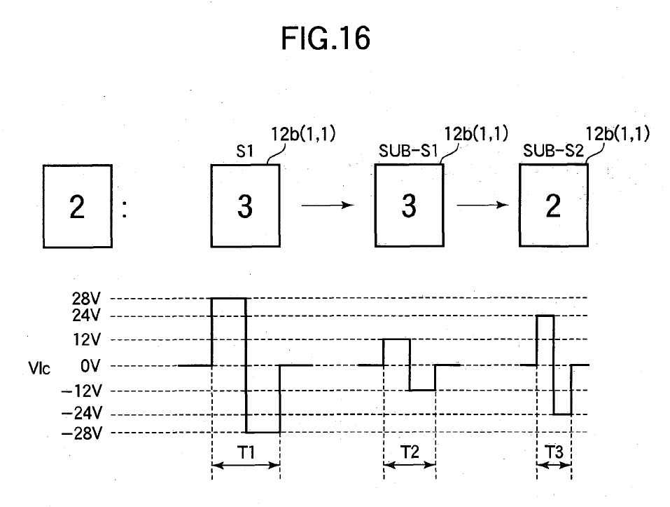

In order to display gray level “2” at the B pixel 12b (1,1), as shown in Table 1 and FIG. 16, a pulse voltage V1c of ±28 V is first applied at step S1 for a period of 4.0 ms. As a result, the cholesteric liquid crystal undergoes a transition from the previous state of alignment, and gray level “3” is obtained. Then, a pulse voltage V1c of ±12 V for keeping the state of the liquid crystal unchanged is applied at sub-step S1 to maintain gray level “3”. Next, a pulse voltage V1c of ±24 V is applied for 1.0 ms at sub-step S2 to cause a transition of the cholesteric liquid crystal toward the focal conic state. Thus, gray level “2” that is one step lower than level “3” is obtained.

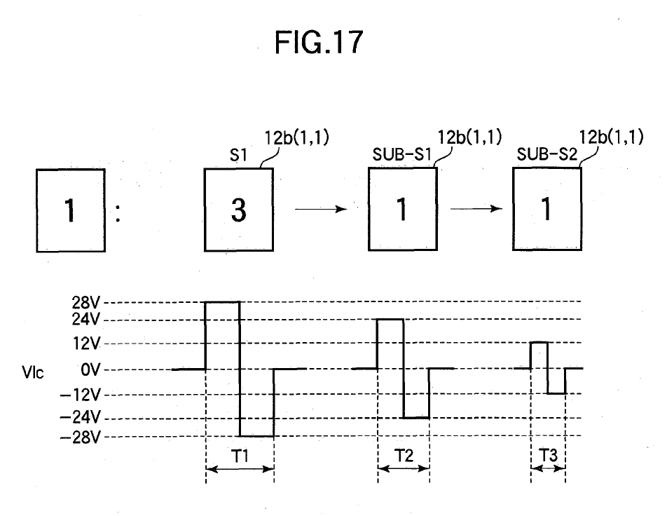

In order to display gray level “1” at the B pixel 12b (1,1), as shown in Table 1 and FIG. 17, a pulse voltage V1c of ±28 V is first applied at step S1 for a period of 4.0 ms. As a result, the cholesteric liquid crystal undergoes a transition from the previous state of alignment, and gray level “3” is obtained. Then, a pulse voltage V1c of ±24 V is further applied for 2.0 ms at sub-step S1 to lower the gray level two steps, whereby gray level “1” is obtained. A pulse voltage V1c of ±12 V for keeping the state of the liquid crystal unchanged is applied at sub-step S2 to display gray level “1”.

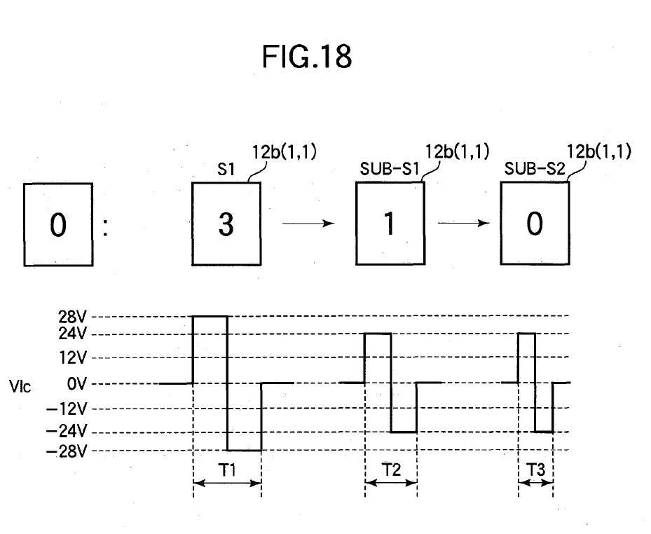

In order to display gray level “0 (black)” at the B pixel 12b (1,1), as shown in Table 1 and FIG. 18, a pulse voltage V1c of ±28 V is first applied at step S1 for a period of 4.0 ms. As a result, the cholesteric liquid crystal undergoes a transition from the previous state of alignment, and gray level “3” is obtained. Then, a pulse voltage V1c of ±24 V is further applied for 2.0 ms at sub-step S1 to lower the gray level two steps, whereby gray level “1” is obtained. At sub-step S2, a pulse voltage V1c of ±24 V is further applied for 1.0 ms to cause a transition of the cholesteric liquid crystal toward the focal conic state further. Thus, gray level “0” that is one step lower than level “1” is obtained.

Although eight gray levels are provided in the present embodiment, 16 or more gray levels can be displayed by increasing the number of sub-steps. The number of gray levels can be doubled each time one sub-step is added. For example, 16 gray levels can be displayed when a liquid crystal is driven four times, and 64 gray levels can be displayed when it is driven six times. Two gray levels are displayed when a liquid crystal is driven once. As thus described, according to the multi-level display method of the present embodiment, the number of writes required for writing N gray levels is log₂N.

When the green (G) pixel 12g (1,1) and the red (R) pixel 12r (1,1) are driven in the same manner as for the B pixel 12b (1,1) as described above, 512 (in the case of eight gray levels) or more colors can be displayed (multi-level display) at the pixel 12 (1,1) which is formed by stacking the three pixels, i.e., the B, G, and R pixels 12b (1,1), 12g (1,1), and 12r (1,1) one over another. By driving the scan electrodes 17b, 17g, and 17r on the first to 240th lines in the so-called line sequential manner (line sequential scan) to rewrite data voltages of the data electrodes 19b, 19g, and 19r on each line a predetermined number of times, display data can be output to all pixels from the pixel 12 (1,1) up to the pixel 12 (240, 320) to perform color display of one frame (display screen).

According to the above-described multi-level display method, there is no need for driver IC of special specifications capable of generating multi-level driving waveforms, and multi-level display can be implemented using binary general-purpose drivers which are inexpensive. Therefore, multi-level (multi-tone) display can be achieved at a low cost.

Points to be noted with respect to the driving operation at step S1 will now be described.

As shown in FIG. 4, in the intermediate gray level region B which is, in general, a region where transition from the focal conic state to the planar state takes place, there is hysteresis which appears on the curves P and FC as different reflectances resulting from the same applied voltages. Such hysteresis is attributable to the initial state of the liquid crystal of interest, and the characteristics of the intermediate gray level region B are shifted depending on whether the initial state is the planar state or it is the focal conic state. Therefore, when level “3” is written at step S1 of the present embodiment utilizing the intermediate gray level region B, the hysteresis of the intermediate gray level region B must be eliminated. Although the hysteresis can be eliminated by reducing the scanning speed of the scan electrode 17 of interest to make the pulse width of pulse voltage relatively great, the reduction of the scanning speed is undesirable because it increases time required for image rewriting.

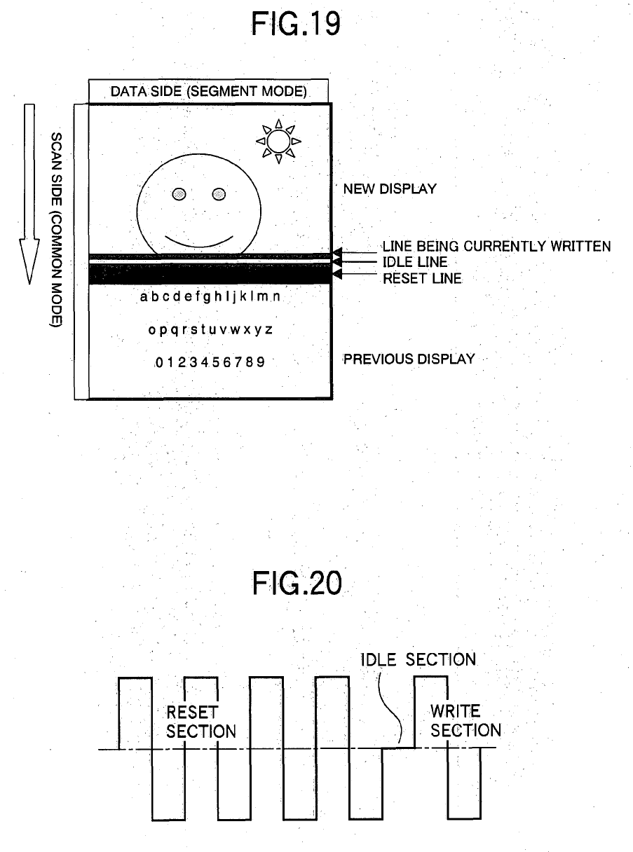

FIGS. 19 to 21 show an embodiment of the invention which represents a driving method allowing hysteresis to be eliminated with scanning speed kept relatively high. The present embodiment is also advantageous in that a display screen can be reset at power consumption lower than that of screen rewriting methods involving a process of resetting an entire display screen at a time. In the present embodiment, a liquid crystal is sequentially reset to the homeotropic state or focal conic state several lines at a time at the first step (step S1) of the multi-level display method. As shown in FIG. 19, for example, a screen is rewritten by resetting four lines at a time and simultaneously repeating an operation of writing data of one line number of times equal to the number of lines. Thus, hysteresis of the intermediate gray level region B can be eliminated.

FIG. 20 shows a voltage applied to each pixel on one scan electrode 17 during a screen rewrite. A positive/negative alternating pulse is applied to each pixel at a time. The reset pulse is applied to the liquid crystal at one pixel plural number of times, i.e., four times, as shown in FIG. 20. An idle section follows the reset pulses, and a write voltage is applied in a write section which follows the idle section.

The use of this reset driving method allows a first or second predetermined reflectance value to be obtained at step S1 at low power consumption and high speed without concern about hysteresis. Further, write data itself is used for resetting, which eliminates the need for using special data for resetting, e.g., reset data for rendering white at all pixels.

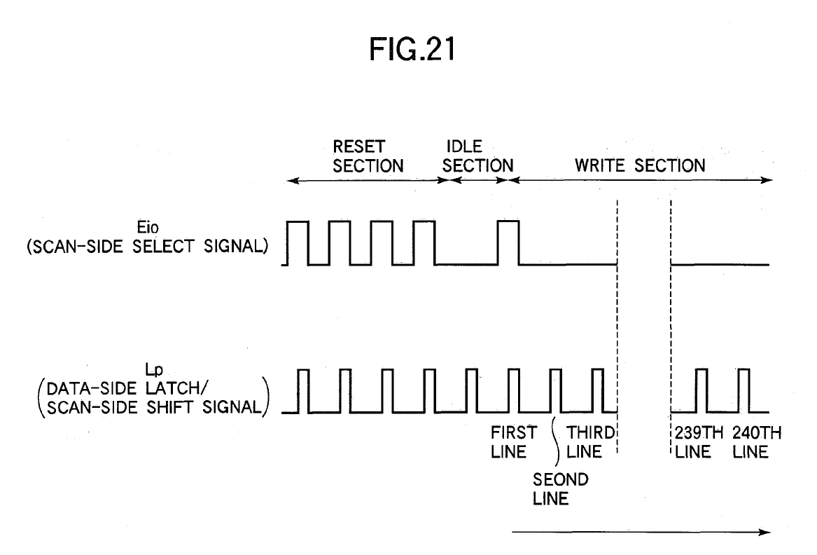

The lower half of the screen shown in FIG. 19 is a part of a screen which has been previously displayed, and the upper half is a part of a newly displayed screen. A common mode is a line-sequential scan mode in which the scan electrodes 17 are sequentially scanned, and a segment mode is a mode in which an applied voltage can be selected for each data electrode 19. The scan side driver sequentially selects scan electrodes (scan lines) and outputs “ON” scan pulses to them, and the data electrode side driver outputs a pulse of “ON” data or “OFF” data depending on data to be displayed. FIG. 19 shows a state in which a line being currently written, that is, writing of one line at a time as described above started at the uppermost scan line has proceeded up to a line substantially in the middle of the screen. Data is being written on the line, and resetting is being simultaneously performed on, for example, four reset lines using write data. The operation will be detailed with reference to FIG. 21.

As shown in FIG. 21, an operation of setting four lines as reset lines is first performed. Referring to FIG. 21, when an Eio signal which is a scan start signal from the scan side and an Lp signal which gives timing for data latching and scan shifting are simultaneously input, the uppermost line of the screen shown in FIG. 19 is selected to enable writing of data on the line. When second pulses of the Eio and Lp signals are simultaneously input, the Lp signal causes a shift from the first line which has been first selected, and the second line is thus selected. The first line is also simultaneously selected by the Eio signal that is simultaneously input. Thus, both of the first line and the second line are selected. Such an operation is repeated to put the first to fourth lines in a selected state in the reset line setting section, and data can be written on the four lines.

In the subsequent section that is an idle line setting section, only the Lp signal is input, and the pulse makes a one line shift to put the second to fifth lines on the screen in the selected state.

At the beginning of the subsequent section that is a write section, the Eio signal and the Lp signal are simultaneously input to make a one line shift from the second to fifth lines which have been previously selected. As a result, the third to sixth lines are selected, and the input of the Eio signal keeps the first line on the screen in the selected state. Data is supplied to the first line in this state to write data which is the actual data to be written on the first line, and the data for the first line is also supplied to the third to sixth lines as data for resetting to reset the data which has been previously displayed on those lines. At this time, the second line is in an idle state which has been set in the idle line setting section, and no data is written on the line.

The input of the next Lp pulse results in a shift of the lines which have been selected, and the second line and the fourth to seventh lines are selected. In the state, data for the second line is supplied to write data which should be actually written in on the second line, and the data which has been previously displayed on the fourth to seventh lines is reset.

When another Lp pulse is input, the third line and the fifth to eighth lines are similarly selected, and data is written on the third line. The third line has the data for the first line which has been written by the Lp pulse input two cycles before the current pulse. In general, the response time of a cholesteric liquid crystal is on the order of several tens ms, although it depends on the physical properties of the liquid crystal. When the Lp pulse is input as timing of the writing of data on the second line, the third line is in the idle section, and the pixels on the third line in this section (e.g., 50 ms or less) are in a transient state in transition to the focal conic state or planar state. When the data for the third line is actually supplied, the pixels are put in an actual write state, i.e., the focal conic state or the planar state. For example, such an operation is repeated up to the 240th line or until data is written for the lowermost line of the screen.

Since the liquid crystal can be sufficiently reset according to this reset driving method, the generation of hysteresis in the intermediate gray level region B can be prevented regardless of the initial state of the liquid crystal.

The above described step S1, sub-step S1, and sub-step S2 may be performed in different frames to complete image rewriting in three frames in total. An alternative approach is to perform the first step (step S1) in one frame and to perform the second step (sub-steps S1 and S2) in another frame. Further, all of step S1, sub-step S1, and sub-step S2 of image rewriting may be completed in one frame.

When a plurality of steps are performed in one frame, the plurality of steps may be performed at one cycle of scanning. For example, in the case of the approach for completing image rewriting in three frames in total, three cycles of scanning may be performed in total to complete the first and second steps. However, a smaller number of scans results in less flickers during writing, which is more comfortable for a viewer. Therefore, latch pulses for a plurality of steps are applied at one scan in order to reduce the number of scans. Thus, the number of scans can be kept small to perform image rewriting with less flickers.

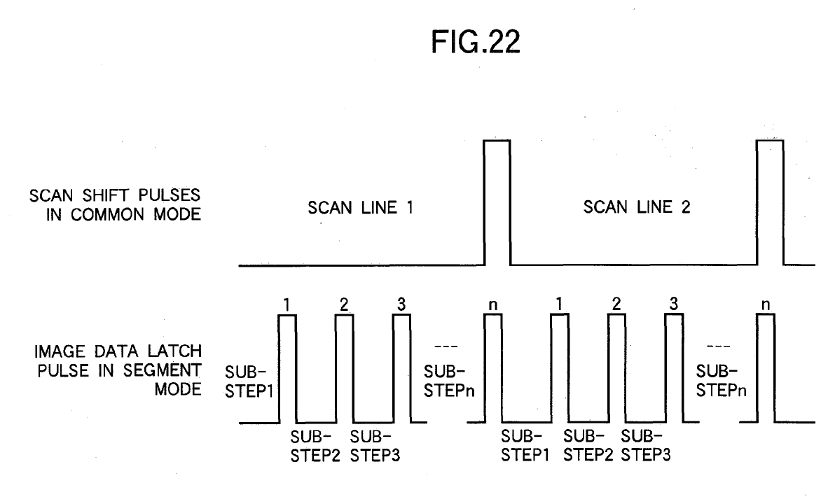

A method of driving for allowing first to n-th sub-steps of the second step to be executed in one scan will now be described with reference to FIG. 22. FIG. 22 shows a relationship between scanning pulses (scan shift pulses in the common mode) and data latch pulses (image data latch pulses in the segment mode). As shown in FIG. 22, pulse voltages at the first to n-th sub-steps are applied within one scan line. Thus, an image can be written with less flickers.

When both of the first step (step S1) and the second step (sub-steps S1 and S2) are performed in one frame, a time interval of several ms to several tens ms must be provided between the first and second steps. The reason is that it takes several ms to several tens ms for the liquid crystal to enter the planar state after the pulse application at step S1 is stopped.

It is also preferable to perform the first and second steps independently of each other. Specifically, it is preferable to perform the first step to write an image of one frame independently and to perform writing at the second step in another frame. Thus, a user can perceive an image as a whole earlier when the image is written at the first step.

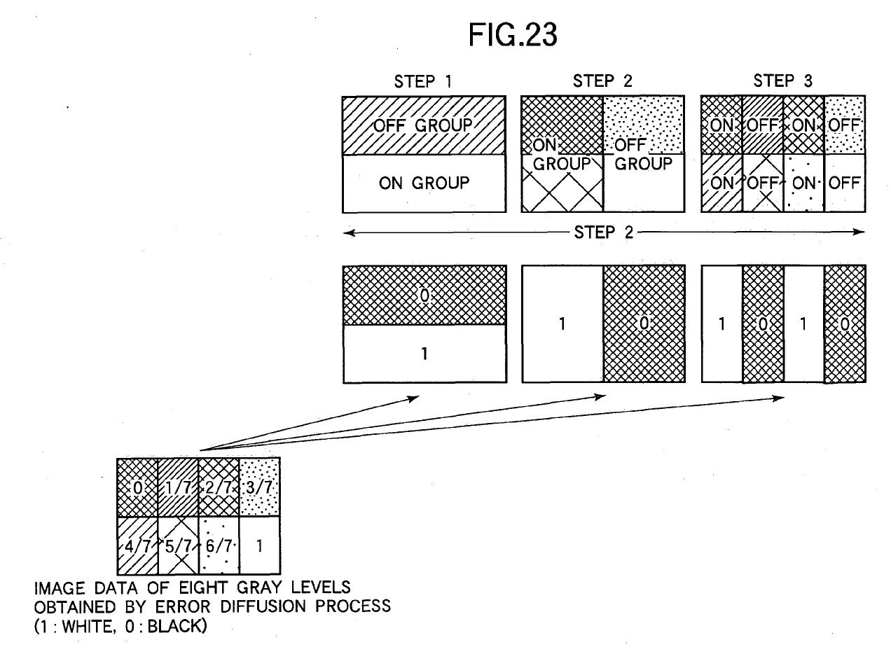

A description will now be made with reference to FIG. 23 on a process of generating image data at low gray levels to be used for driving a display element from image data having higher gray levels. FIG. 23 shows a process of converting image data having high gray levels into image data having eight lower gray levels using, for example, the error diffusion method. As described above, eight gray levels are displayed by applying three pulses in total at the first and second steps. As shown in FIG. 23, image data is processed by splitting the image of interest having eight gray levels into eight pixels according to the pulses to be applied. Pixel data “1” is allocated to pixels to be put in the planar state at the first step, and pixel data “0” is allocated to pixels to be rendered at an intermediate gray level.

In a part of the process corresponding to the second step, pixel data “1” is allocated to pixels to be changed to a different gray level, and pixel data “0” is allocated to pixels to be kept at the same gray level. That is, pixel data is generated for each pixel in the form of binary data representing an ON pulse (1) or an OFF pulse (0). Referring to algorithm for such gray level conversion, the error diffusion method and blue noise mask method are preferred in terms of image quality.

An example of a method of manufacturing a liquid crystal display element 1 will now be briefly described.

ITO transparent electrodes are formed on two polycarbonate (PC) film substrates cut to have longitudinal and transversal lengths of 10 (cm)×8 (cm), and they are patterned through etching to form electrodes (scan electrodes 17 or data electrodes 19) in the form of stripes at a pitch of 0.24 mm on each substrate. Thus, electrodes in the form of stripes are formed on each of the two PC film substrates to allow QVGA display of 320×240 dots. Next, a polyimide type alignment film material is applied using spin coating on the transparent electrodes 17 and 19 in the form of stripes on two respective PC film substrates 7 and 9 to a thickness of about 700 A. Next, the two PC film substrates 7 and 9 having the alignment film material applied thereon are baked for one hour in an oven at 90° C. to form alignment films. Then, an epoxy type seal material 21 is applied to a peripheral part of either of the PC film substrates 7 and 9 using a dispenser to form a wall having a predetermined height.

Next, spacers having a diameter of 4 μm (manufactured by SEKISUI FINE CHEMICAL) are dispersed on the other PC film substrate 9 or 7. Then, the two PC film substrates 7 and 9 are combined and heated for one hour at 160° C. to cure the seal material 21. Then, after injecting a B cholesteric liquid crystal LCb using a vacuum injection process, the injection port is sealed with an epoxy type sealing material to fabricate a B display portion 6b. G and R display portions 6g and 6r are fabricated using the same method.

Next, a shown in FIG. 2, the B, G, and R display portions 6b, 6g, and 6r are stacked in the order listed from the side of a display surface. Then, a visible light absorbing layer 15 is disposed on a bottom surface of a bottom substrate 9r of the R display portion 6r. General purpose STN driver ICs in a TCP (tape carrier package) structure are then crimped to terminal parts of scanning electrodes 17 of the B, G, and R display portions 6b, 6g, and 6r stacked one over another and terminal parts of data electrodes 19 thereof, and a power supply circuit and a control circuit section 23 are further connected. Thus, a liquid crystal display element 1 capable of QVGA display is completed. Although not shown, electronic paper is completed by providing the liquid crystal display element 1 thus completed with an input/output device and a control device for exercising overall control of the element (neither of which is shown).

An example of the driving device including the control circuit section 23 according to the present embodiment will now be described with reference to FIG. 24. FIG. 24 shows a configuration of major circuits of the control circuit section 23 that is shown as a block in FIG. 1, along with a schematic illustration of the configuration shown in FIG. 1.

The control circuit section 23 includes a control portion 30 which outputs image data to be used at the first and second steps to the data electrode driving circuit 27 at predetermined timing, the image data being obtained by converting externally input image data (original image) using the gray level conversion method described with reference to FIG. 23. The control portion also outputs various control data to the scan electrode driving circuit 25 and the data electrode driving circuit 27. Specifically, image data output to the scan electrode driving circuit 25 and the data electrode driving circuit 27 is obtained by converting a full-color original image into 512 gray levels using the error diffusion method and further converting the resultant data into binary image data associated with each of the above-described steps using the image data generation method described with reference to FIG. 23.

A scan/data mode signal output from the control portion 30 is a switching signal determining which of the drivers in the scan electrode driving circuit 25 and the data electrode driving circuit 27 is to be used. A data fetching clock is a signal indicating timing for fetching image data. A frame start signal is a synchronization signal for starting writing of one screen on a display screen. A pulse polarity control signal is a signal for inverting an output from the control portion to generate an alternating pulse. A data latch/scan shift signal is a signal for exercising control for shifting a scan electrode line to the next scan electrode line in order to perform line-sequential scanning of the scan electrodes 17 and for exercising control over latching of data signals. A driver output turn-off signal is a signal for nullifying the driver output by force.

Driving voltages input to the scan electrode driving circuit 25 or the data electrode driving circuit 27 are obtained by boosting a logical voltage of 3 to 5 V output from a power supply portion 31 into a voltage of 36 to 40 V using a boosting portion 32 having a regulator such as a DC-DC converter, supplying the resultant voltage to a voltage switching portion 34 to perform resistive potential division, and forming the resultant voltages into various voltage outputs at a voltage stabilizing portion 35. The various voltage outputs from the voltage stabilizing portion 35 are specifically the voltages of 32, 30, 28, 4, 2, and 0 V used at the first step and the voltages of 24, 18, 12, 12, 6, and 0 V used at the second step. Based on image control data output by the control portion 30, the scan electrode driving circuit 25 and the data electrode driving circuit 27 select any of the plurality of voltage values output from the voltage stabilizing portion 35. The power supply portion 31 supplies predetermined electric power to the control portion 30, a clock oscillating portion 36, and a frequency-division circuit portion 37 in addition to the boosting portion 32.

For example, an analog switch Max 4535 having a withstand voltage of 36 V (not shown) manufactured by Maxim Integrated Products may be used in the voltage stabilizing portion 35 as an analog switch for switching the pulse voltages used at the first and second steps. A voltage input to the driver is preferably stabilized by a voltage follower of an operational amplifier provided downstream of the analog switch. More preferably, the operational amplifier is a type of product that is resistant to a capacitive load such as a liquid crystal element. As a result, at the first step, stable pulse voltages of ±32 V and ±28 V are applied to ON and OFF pixels, respectively, and a pulse voltage of ±2 V is applied to unselected pixels. Scanning at the first step is performed at a scan speed (selection period) of about 4.0 ms/line.

In a general-purpose driver, scan shifting in the common mode and data latching in the segment mode are performed using the same terminal (LP). It is preferable to perform those operations independently of each other. Such independent operations will allow writing to be completed in one line as described above with reference to FIG. 22.

At the second step, pulse voltages of ±24 V and ±12 V are applied to ON and OFF pixels, respectively, and a pulse voltage of ±6 V is applied to unselected pixels. The scanning speed of the second step is 3.0 ms/line which is a result of the combination of sub-step S1 employing a pulse width of 2.0 ms and sub-step S2 employing a pulse width of 1.0 ms.

In order to switch scanning speed, there is provided the frequency division circuit portion 37 to which a clock output from the clock oscillating portion 36 is input and which outputs the clock after performing frequency division of the clock at a predetermined frequency division ratio. A bit array for controlling scanning speed is input from the control portion 30 to the frequency division circuit portion 37 to modulate the frequency division ratio of a counter for controlling the scanning speed according to the value of the bit array. Specifically, the initial value of the frequency division counter (not shown) provided in the frequency division circuit portion 37 may be switched for each scan. In the case of writing of 512 colors, since the scanning speed is switched between three values at the first and the second steps, the number of bits required for pulse width switching is two. In this case, while eight bits of data are required for each pixel according to the PWM method in the related art, the amount of data required in the present embodiment is only five bits in total, i.e., three bits required for step S1, sub-step S1, and sub-step S2 plus two bits required for pulse width switching. Thus, 512 colors can be displayed with high uniformity.

Another example of the driving device including the control circuit section 23 will now be described by explaining an example of display of 4096 colors with a color display element. Image data input to the data electrode driving circuit 27 is obtained by converting a full-color original image into 4096 gray levels using the error diffusion method. The first step is performed at a scanning speed of about 4.0 ms/line. The second step is performed at a scanning speed of 3.5 ms/line which is a result of a combination of sub-step S1 employing a pulse width of 2.0 ms, sub-step S2 employing a pulse width of 1.0 ms, and sub-step S3 employing a pulse width of 0.5 ms. The image data is further converted into binary image data associated with each of the steps using the image data generating method described above with reference to FIG. 23. In the case of writing of 4096 colors, since four pulse widths are switchedly used at the first and the second steps, the number of bits required is two. In this case, while 16 bits of data are required for each pixel according to the PWM method in the related art, the amount of data required in the present embodiment is only six bits in total, i.e., four bits required for step S1, sub-step S1, sub-step S2, and sub-step S3 plus two bits required for scan speed switching.

For example, 260000 colors having 64 each R, G, and B gray levels can be displayed using steps similar to those described above. In this case, since 64 each R, G, and B gray levels can be written at six steps, only three bits are required for pulse width switching. While 64 bits of data are required for each pixel according to the PWM method in the related art, the amount of data required in the present embodiment is only nine bits in total, i.e., six bits required for step S1, sub-step S1, sub-step S2, sub-step S3, sub-step S4, and sub-step S5 plus three bits required for scan speed switching.

As described above, when the driving method of the present embodiment is used to drive a display element utilizing cholesteric liquid crystals, multi-level display of high quality can be achieved with a minimum amount of data using inexpensive general-purpose drivers that provide binary output.

The invention is not limited to the above-described embodiment and may be modified in various ways.

Although the above embodiment has been described as using the line-sequential driving (line-sequential scanning) method as a driving method as an example, the driving method may be point-sequential driving method.

The above embodiment has been described as a liquid crystal display element having a three-layer structure formed by stacking B, G, and R display portions 6b, 6g, and 6r one over another as an example. However, the invention is not limited to such an element and may be applied to liquid crystal display elements having a structure with one or two layers or four or more layers.

The above embodiment has been described as a liquid crystal display element including display portions 6b, 6g, and 6r having liquid crystal layers 3b, 3g, and 3r for reflecting blue, green, and red rays of light in the planar state, as an example. However, the invention is not limited to such an element and may be applied to liquid crystal display elements including three display portions having liquid crystal layers for reflecting cyan, magenta, and yellow rays of light in the planar state.

As described above, when the driving method of the present embodiment is used to drive a display element utilizing cholesteric liquid crystals, multi-level display of high quality can be achieved with a minimum amount of data using inexpensive general-purpose drivers that provide binary output.

What is claimed is:

1. A method of driving a liquid crystal display element for displaying gray levels by changing a reflectance of a liquid crystal layer, the method comprising:
a first step of changing the reflectance of the liquid crystal layer to a first reflectance value to obtain a first gray level; and
a second step of changing the reflectance of the liquid crystal layer to a second reflectance value lower than the first reflectance value to obtain a second gray level lower than the first gray level.

2. The method according to claim 1, wherein the second step includes n sub-steps to gradually decrease the first reflectance value to the second reflectance value.

3. The method according to claim 2, wherein N gray levels (N is a power of 2) are displayed by the first step and the sub-steps totaling at a number of steps log₂N.

4. The method according to claim 3, wherein the first reflectance value is either of two reflectance values one of which is substantially one half of the other.

5. The method according to claim 1, wherein the first step includes applying a first voltage having a first pulse width between a pair of electrodes sandwiching the liquid crystal layer to generate the first reflectance value.

6. The method according to claim 5, wherein the second step includes n sub-steps applying a voltage lower than the first voltage having a pulse width smaller than the first pulse width between the electrodes to generate the second reflectance value.

7. The method according to claim 6, wherein the liquid crystal layer has a first intermediate gray level region in which an increase in an applied voltage results in a decrease in reflectance and a second intermediate gray level region which is a voltage range higher than a voltage range associated with the first intermediate gray level region and in which an increase in an applied voltage results in an increase in reflectance;
the first voltage at the first step is in the second intermediate gray level region; and
the low voltage at the second step is in the first intermediate gray level region.

8. The method according to claim 5, wherein the liquid crystal layer includes a liquid crystal which forms a cholesteric phase.

9. The method according to claim 8, wherein the first reflectance value is generated when the liquid crystal is in a planar state or a state that is a mixture of the planar state and a focal conic state.

10. The method according to claim 8, wherein the first step includes the step of resetting the liquid crystal to a homeotropic state or the focal conic state before changing the reflectance of the liquid crystal layer to the first reflectance value.

11. The method according to claim 6, wherein one of the pair of electrodes is one of scan electrodes sequentially scanned in one frame to select a plurality of pixels on one line and the other electrode is one of data electrodes for applying a data voltage to each of the pixels; and
the first step and the second step are performed in different frames.

12. The method according to claim 11, wherein a selection period for the scan electrode is varied to control each pulse width used at the sub-steps.

13. The method according to claim 12, wherein a bit array for controlling the selection period is provided to modulate a frequency division ratio of a counter for controlling the selection period according to the value of the bit array.

14. A liquid crystal display element comprising:
a liquid crystal layer enclosed between a pair of substrates;
a pair of electrodes sandwiching the liquid crystal layer; and
a driving device for displaying gray levels by performing a first step of changing a reflectance of the liquid crystal layer to a first reflectance value to obtain a first gray level and a second step of changing the reflectance of the liquid crystal layer to a second reflectance value lower than the first reflectance value to obtain a second gray level lower than the first gray level.

15. The liquid crystal display element according to claim 14, wherein the driving device performs n sub-steps at the second step to gradually decrease the first reflectance value to the second reflectance value for displaying gray levels.

16. The liquid crystal display element according to claim 15, wherein N gray levels (N is a power of 2) are displayed by the first step and the sub-steps totaling at a number of steps log₂N by the driving device.

17. The liquid crystal display element according to claim 16, wherein the first reflectance value is either of two reflectance values one of which is substantially one half of the other.

18. The liquid crystal display element according to claim 14, wherein the driving device applies a first voltage having a first pulse width between a pair of electrodes to generate the first reflectance value at the first step.

19. The liquid crystal display element according to claim 18, wherein the driving device performs n sub-steps in the second step to apply a voltage lower than the first voltage having a pulse width smaller than the first pulse width between the electrodes to generate the second reflectance value.

20. The liquid crystal display element according to claim 19, wherein the liquid crystal layer has a first intermediate gray level region in which an increase in an applied voltage results in a decrease in reflectance and a second intermediate gray level region which is a voltage range higher than a voltage range associated with the first intermediate gray level region and in which an increase in an applied voltage results in an increase in reflectance; and
the driving device uses a voltage in the second intermediate gray level region as the first voltage of the first step and a voltage in the first intermediate gray level region as the lower voltage of the second step.

21. The liquid crystal display element according to claim 18, wherein the liquid crystal layer includes a liquid crystal which forms a cholesteric phase.

22. The liquid crystal display element according to claim 21, wherein the first reflectance value is generated when the liquid crystal is in a planar state or a state that is a mixture of the planar state and a focal conic state.

23. The liquid crystal display element according to claim 21, wherein the driving device performs a step included in the first step to reset the liquid crystal to a homeotropic state or the focal conic state before changing the reflectance of the liquid crystal layer to the first reflectance value.

24. The liquid crystal display element according to claim 19, wherein one of the pair of electrodes is one of scan electrodes sequentially scanned in one frame to select a plurality of pixels on one line and the other electrode is one of data electrodes for applying a data voltage to each of the pixels; and
the first step and the second step are performed in different frames.

25. The liquid crystal display element according to claim 24, wherein the driving device varies a selection period for the scan electrode to control each pulse width used at the sub-steps.

26. The liquid crystal display element according to claim 25, wherein the driving device has a bit array for controlling the selection period to modulate a frequency division ratio of a counter for controlling the selection period according to the value of the bit array.

27. Electronic paper displaying an image, comprising a liquid crystal display element according to claim 14.
